(19) United States
(12) Patent Application Publication
(10) Pub. No.: US 2026/0181724 A1
(43) Pub. Date: Jun. 25, 2026

(54) AUTONOMOUS DISCONTINUOUS RECEPTION CYCLES IN WIRELESS COMMUNICATIONS SYSTEMS

(71) Applicant: QUALCOMM Incorporated, San Diego, CA (US)

(72) Inventors: Hyun Yong LEE, San Diego, CA (US); Gavin Bernard HORN, La Jolla, CA (US); Ozcan OZTURK, San Diego, CA (US); Linhai HE, San Diego, CA (US); Qing LI, PRINCETON JUNCTION, NJ (US); Sitaramanjaneyulu KANAMARLAPUDI, San Diego, CA (US); Peerapol TINNAKORNSRISUPHAP, San Diego, CA (US)

(21) Appl. No.: 18/999,535

(22) Filed: Dec. 23, 2024

(51) Int. Cl. H04W 76/28; H04W 72/232; H04W 76/27

(52) U.S. Cl. CPC H04W 76/28; H04W 72/232; H04W 76/27

(57) ABSTRACT

Methods, systems, and devices for wireless communications are described. A user equipment (UE) may autonomously enter an inactive state during one or more discontinuous reception (DRX) cycles. The UE may receive first control signaling indicating multiple DRX cycles. During an active state of a first DRX cycle, the UE may receive second control signaling indicating that the UE is permitted to autonomously enter the inactive state for one or more DRX cycles of the multiple DRX cycles. Accordingly, the UE may transmit third control signaling that includes an inactive state indication indicating that the UE is to enter the inactive state. The UE may determine to transmit the inactive state indication according to an output of an artificial intelligence or machine learning model at the UE. Based on transmitting the inactive state indication, the UE may enter the inactive state.

### FIELD OF TECHNOLOGY

The following relates to wireless communications, including autonomous discontinuous reception (DRX) cycles in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, the UE may operate according to a discontinuous reception (DRX) cycle, in which the UE operates in an active state (e.g., radio resource control (RRC) connected state, active communication state) for a first duration (e.g., DRX on-duration) and an inactive state (e.g., RRC inactive state, RRC idle state, reduced power mode) for a second duration (e.g., DRX off-duration). While operating in the inactive state of the DRX cycle, the UE may refrain from receiving signals, which may reduce power consumption at the UE and improve battery life at the UE, among other advantages. To facilitate the DRX cycle, a network entity may indicate a DRX configuration (e.g., information related to one or more DRX cycles) to the UE, which may include one or more parameters associated with a DRX cycle, such as the first duration, the second duration, and/or various timers, among other examples. The UE may alternate in the DRX cycle between the active state and the inactive state according to the DRX configuration.

In some cases, it may be beneficial for the UE to autonomously enter the inactive state, for example, in cases where the UE may not have data to be communicated but is otherwise operating in the active state. In such cases, however, because the DRX configuration is controlled by the network entity, the UE may not have the flexibility to autonomously enter the inactive state, thereby increasing power consumption at the UE and/or degrading user experience, among other disadvantages.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling indicating a set of multiple discontinuous reception (DRX) cycles, where each DRX cycle of the set of multiple DRX cycles includes a respective first duration associated with an active state at the UE, a respective second duration associated with an inactive state at the UE, or both, receiving, during the active state of a first DRX cycle, second control signaling indicating that the UE is permitted to autonomously enter the inactive state for one or more DRX cycles of the set of multiple DRX cycles, transmitting, in accordance with receiving the second control signaling, third control signaling including an inactive state indication indicating that the UE is to enter the inactive state, where the inactive state indication of the UE is in accordance with an output of an artificial intelligence model at the UE, and entering the inactive state.

A UE for wireless communications is described. The UE may include one or more memories storing processor executable code, and one or more processors coupled with the one or more memories. The one or more processors may individually or collectively be operable to execute the code to cause the UE to receive first control signaling indicating a set of multiple DRX cycles, where each DRX cycle of the set of multiple DRX cycles includes a respective first duration associated with an active state at the UE, a respective second duration associated with an inactive state at the UE, or both, receive, during the active state of a first DRX cycle, second control signaling indicating that the UE is permitted to autonomously enter the inactive state for one or more DRX cycles of the set of multiple DRX cycles, transmit, in accordance with receiving the second control signaling, third control signaling including an inactive state indication indicating that the UE is to enter the inactive state, where the inactive state indication of the UE is in accordance with an output of an artificial intelligence model at the UE, and enter the inactive state.

Another UE for wireless communications is described. The UE may include means for receiving first control signaling indicating a set of multiple DRX cycles, where each DRX cycle of the set of multiple DRX cycles includes a respective first duration associated with an active state at the UE, a respective second duration associated with an inactive state at the UE, or both, means for receiving, during the active state of a first DRX cycle, second control signaling indicating that the UE is permitted to autonomously enter the inactive state for one or more DRX cycles of the set of multiple DRX cycles, means for transmitting, in accordance with receiving the second control signaling, third control signaling including an inactive state indication indicating that the UE is to enter the inactive state, where the inactive state indication of the UE is in accordance with an output of an artificial intelligence model at the UE, and means for entering the inactive state in accordance with transmitting the third control signaling.

A non-transitory computer-readable medium storing code for wireless communications is described. The code may include instructions executable by one or more processors to receive first control signaling indicating a set of multiple DRX cycles, where each DRX cycle of the set of multiple DRX cycles includes a respective first duration associated with an active state at the UE, a respective second duration associated with an inactive state at the UE, or both, receive, during the active state of a first DRX cycle, second control signaling indicating that the UE is permitted to autonomously enter the inactive state for one or more DRX cycles of the set of multiple DRX cycles, transmit, in accordance with receiving the second control signaling, third control signaling including an inactive state indication indicating that the UE is to enter the inactive state, where the inactive state indication of the UE is in accordance with an output of an artificial intelligence model at the UE, and enter the inactive.

Some examples of the method, UEs, and non-transitory computer-readable medium described herein may further include operations, features, means, or instructions for receiving, in accordance with transmitting the inactive state indication, fourth control signaling confirming that the UE may be permitted to enter the inactive state, where entering the inactive state may be in accordance with receiving the fourth control signaling.

Some examples of the method, UEs, and non-transitory computer-readable medium described herein may further include operations, features, means, or instructions for receiving fifth control signaling indicating for the UE to refrain from entering the inactive state until reception of the fourth control signaling, where receiving the fourth control signaling may be in accordance with receiving the fifth control signaling.

In some examples of the method, UEs, and non-transitory computer-readable medium described herein, the fourth control signaling includes an indication of a power state of the UE while in the inactive state, a duration associated with operating in the inactive state, or both.

In some examples of the method, UEs, and non-transitory computer-readable medium described herein, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples of the method, UEs, and non-transitory computer-readable medium described herein, the fourth control signaling indicates a second DRX cycle of the set of multiple DRX cycles in which the UE may be to enter the active state from the inactive state.

Some examples of the method, UEs, and non-transitory computer-readable medium described herein may further include operations, features, means, or instructions for receiving fourth control signaling including assistance information associated with the artificial intelligence model at the UE, where the UE uses the assistance information as inputs into the artificial intelligence model at the UE, and where transmitting the third control signaling may be in accordance with the assistance information.

In some examples of the method, UEs, and non-transitory computer-readable medium described herein, the assistance information includes a periodicity metric associated with each communication flow between the UE and a network entity, a jitter metric associated with each communication flow between the UE and the network entity, a priority associated with each communication flow between the UE and the network entity, a packet data unit set delay budget (PDSB) associated with each communication flow between the UE and the network entity, a size of a downlink buffer at the network entity, or any combination thereof.

Some examples of the method, UEs, and non-transitory computer-readable medium described herein may further include operations, features, means, or instructions for receiving, in accordance with entering the active state from the inactive state, fourth control signaling including feedback information associated with the artificial intelligence model at the UE and updating the artificial intelligence model at the UE in accordance with the feedback information.

In some examples of the method, UEs, and non-transitory computer-readable medium described herein, the feedback information includes a quantity of downlink control information (DCI) messages missed by the UE while operating in the inactive state, a bitmap indicating one or more DCI messages of a set of multiple DCI messages that were missed by the UE while operating in the inactive state, or both.

In some examples of the method, UEs, and non-transitory computer-readable medium described herein, the feedback information indicates one or more data radio bearers that were included in one or more transport blocks that were missed by the UE while operating in the inactive state.

In some examples of the method, UEs, and non-transitory computer-readable medium described herein, the feedback information includes a quantity of packets missed by the UE while operating in the inactive state, a priority of each packet missed by the UE while operating in the inactive state, a source internet protocol (IP) address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

Some examples of the method, UEs, and non-transitory computer-readable medium described herein may further include operations, features, means, or instructions for determining, using the artificial intelligence model, one or more parameters associated with entering the inactive state in accordance with one or more inputs, where transmitting the third control signaling may be in accordance with the one or more parameters determined using the artificial intelligence model, and where the output of the artificial intelligence model comprises the one or more parameters.

In some examples of the method, UEs, and non-transitory computer-readable medium described herein, the one or more parameters include a time associated with entering the inactive state, a power state of the UE while operating in the inactive state, a duration associated with operating in the inactive state, or any combination thereof.

In some examples of the method, UEs, and non-transitory computer-readable medium described herein, the one or more inputs include a packet data unit delay budget (PDB) associated with each communication flow between the UE and a network entity, a PDSB associated with each communication flow between the UE and the network entity, a priority associated with each communication flow between the UE and the network entity, a latency associated with each communication flow between the UE and the network entity, a packet data unit set completion percentage associated with each communication flow between the UE and the network entity, or any combination thereof.

In some examples of the method, UEs, and non-transitory computer-readable medium described herein, the one or more inputs include an uplink traffic buffer at the UE, a predicted uplink traffic buffer at the UE, one or more operational parameters associated with one or more applications operated by the UE, one or more power parameters at the UE, one or more sleep cycles at the UE, or any combination thereof.

In some examples of the method, UEs, and non-transitory computer-readable medium described herein, the first control signaling includes one or more key performance indicators associated with an accuracy of the artificial intelligence model at the UE and the method, apparatuses, and non-transitory computer-readable medium may include further operations, features, means, or instructions for updating the artificial intelligence model to satisfy the one or more key performance indicators.

In some examples of the method, UEs, and non-transitory computer-readable medium described herein, the one or more key performance indicators include a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

In some examples of the method, UEs, and non-transitory computer-readable medium described herein, entering the inactive state may include operations, features, means, or instructions for entering the inactive state after a duration from transmission of the third control signaling, where the duration may be indicated via the first control signaling, the second control signaling, or a fourth control signaling.

In some examples of the method, UEs, and non-transitory computer-readable medium described herein, the second control signaling further indicates a set of multiple durations associated with operating in the inactive state and the method, apparatuses, and non-transitory computer-readable medium may include further operations, features, means, or instructions for operating within the inactive state for one of the set of multiple durations.

In some examples of the method, UEs, and non-transitory computer-readable medium described herein, each duration of the set of multiple durations includes a respective quantity of DRX cycles associated with operating in the inactive state, a respective quantity of subframes associated with operating in the inactive state, a respective quantity of slots associated with operating in the inactive state, or any combination thereof.

In some examples of the method, UEs, and non-transitory computer-readable medium described herein, the second control signaling further indicates a timer associated with transmission of the third control signaling and the method, apparatuses, and non-transitory computer-readable medium may include further operations, features, means, or instructions for transmitting the third control signaling in accordance with expiration of the timer, where the timer begins in accordance with reception of the second control signaling at the UE.

In some examples of the method, UEs, and non-transitory computer-readable medium described herein, the second control signaling includes a downlink data indicator, a first value of the downlink data indicator indicates that the UE may be to receive one or more downlink signals, and a second value of the downlink data indicator indicates that the UE may be permitted to autonomously enter the inactive state for the one or more DRX cycles.

In some examples of the method, UEs, and non-transitory computer-readable medium described herein, the third control signaling includes an indication of a power state of the UE while operating in the inactive state, a duration associated with operating in the inactive state, or both.

In some examples of the method, UEs, and non-transitory computer-readable medium described herein, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples of the method, UEs, and non-transitory computer-readable medium described herein, the power state of the UE includes an idle DRX power mode, a connected DRX power mode, a short DRX power mode, or a long DRX power mode.

A method for wireless communications by a network entity is described. The method may include outputting first control signaling indicating a set of multiple DRX cycles, where each DRX cycle of the set of multiple DRX cycles includes a respective first duration associated with an active state at a UE, a respective second duration associated with an inactive state at the UE, or both, obtaining second control signaling indicating status information of a set of applications operated by the UE, and outputting third control signaling indicating for the UE to enter the inactive state in accordance with an artificial intelligence model operated at the network entity, where the status information is an input to the artificial intelligence model.

A network entity for wireless communications is described. The network entity may include one or more memories storing processor executable code, and one or more processors coupled with the one or more memories. The one or more processors may individually or collectively be operable to execute the code to cause the network entity to output first control signaling indicating a set of multiple DRX cycles, where each DRX cycle of the set of multiple DRX cycles includes a respective first duration associated with an active state at a UE, a respective second duration associated with an inactive state at the UE, or both, obtain second control signaling indicating status information of a set of applications operated by the UE, and output third control signaling indicating for the UE to enter the inactive state in accordance with an artificial intelligence model operated at the network entity, where the status information is an input to the artificial intelligence model.

Another network entity for wireless communications is described. The network entity may include means for outputting first control signaling indicating a set of multiple DRX cycles, where each DRX cycle of the set of multiple DRX cycles includes a respective first duration associated with an active state at a UE, a respective second duration associated with an inactive state at the UE, or both, means for obtaining second control signaling indicating status information of a set of applications operated by the UE, and means for outputting third control signaling indicating for the UE to enter the inactive state in accordance with an artificial intelligence model operated at the network entity, where the status information is an input to the artificial intelligence model.

A non-transitory computer-readable medium storing code for wireless communications is described. The code may include instructions executable by one or more processors to output first control signaling indicating a set of multiple DRX cycles, where each DRX cycle of the set of multiple DRX cycles includes a respective first duration associated with an active state at a UE, a respective second duration associated with an inactive state at the UE, or both, obtain second control signaling indicating status information of a set of applications operated by the UE, and output third control signaling indicating for the UE to enter the inactive state in accordance with an artificial intelligence model operated at the network entity, where the status information is an input to the artificial intelligence model.

In some examples of the method, network entities, and non-transitory computer-readable medium described herein, the status information includes an indication that a first subset of the set of applications may be associated with a first operational status and a second subset of the set of applications may be associated with a second operational status, the first operational status associated with increased power consumption at the UE relative to the second operational status, and indicating for the UE to enter the inactive state may be based on the indication of the first subset of the set of applications and the second subset of the set of applications.

In some examples of the method, network entities, and non-transitory computer-readable medium described herein, the status information includes an indication of a respective buffer status of each of the set of applications, and indicating for the UE to enter the inactive state may be based on the indication of the respective buffer status of each of the set of applications.

In some examples of the method, network entities, and non-transitory computer-readable medium described herein, the status information includes an indication of a respective traffic time arrival associated with each of the set of applications, and indicating for the UE to enter the inactive state may be based on the indication of the respective traffic time arrival of each of the set of applications.

In some examples of the method, network entities, and non-transitory computer-readable medium described herein, the status information includes an indication of a respective expected event associated with each of the set of applications, and indicating for the UE to enter the inactive state may be based on the indication of the respective expected event of each of the set of applications.

In some examples of the method, network entities, and non-transitory computer-readable medium described herein, the status information includes an indication of a respective traffic priority associated with each of the set of applications, and indicating for the UE to enter the inactive state may be based on the indication of the respective traffic priority of each of the set of applications.

In some examples of the method, network entities, and non-transitory computer-readable medium described herein, the third control signaling further indicates a duration associated with operating in the inactive state and the duration includes a quantity of DRX cycles associated with operating in the inactive state, a quantity of subframes associated with operating in the inactive state, a quantity of slots associated with operating in the inactive state, or any combination thereof.

A method for wireless communications by a network entity is described. The method may include outputting first control signaling indicating a set of multiple DRX cycles, where each DRX cycle of the set of multiple DRX cycles includes a respective first duration associated with an active state at a UE, a respective second duration associated with an inactive state at the UE, or both, outputting, during the active state of a first DRX cycle, second control signaling indicating that the UE is permitted to autonomously enter the inactive state for one or more DRX cycles of the set of multiple DRX cycles, and obtaining, in accordance with outputting the second control signaling, third control signaling including an inactive state indication indicating that the UE is to enter the inactive state.

A network entity for wireless communications is described. The network entity may include one or more memories storing processor executable code, and one or more processors coupled with the one or more memories. The one or more processors may individually or collectively be operable to execute the code to cause the network entity to output first control signaling indicating a set of multiple DRX cycles, where each DRX cycle of the set of multiple DRX cycles includes a respective first duration associated with an active state at a UE, a respective second duration associated with an inactive state at the UE, or both, output, during the active state of a first DRX cycle, second control signaling indicating that the UE is permitted to autonomously enter the inactive state for one or more DRX cycles of the set of multiple DRX cycles, and obtain, in accordance with outputting the second control signaling, third control signaling including an inactive state indication indicating that the UE is to enter the inactive state.

Another network entity for wireless communications is described. The network entity may include means for outputting first control signaling indicating a set of multiple DRX cycles, where each DRX cycle of the set of multiple DRX cycles includes a respective first duration associated with an active state at a UE, a respective second duration associated with an inactive state at the UE, or both, means for outputting, during the active state of a first DRX cycle, second control signaling indicating that the UE is permitted to autonomously enter the inactive state for one or more DRX cycles of the set of multiple DRX cycles, and means for obtaining, in accordance with outputting the second control signaling, third control signaling including an inactive state indication indicating that the UE is to enter the inactive state.

A non-transitory computer-readable medium storing code for wireless communications is described. The code may include instructions executable by one or more processors to output first control signaling indicating a set of multiple DRX cycles, where each DRX cycle of the set of multiple DRX cycles includes a respective first duration associated with an active state at a UE, a respective second duration associated with an inactive state at the UE, or both, output, during the active state of a first DRX cycle, second control signaling indicating that the UE is permitted to autonomously enter the inactive state for one or more DRX cycles of the set of multiple DRX cycles, and obtain, in accordance with outputting the second control signaling, third control signaling including an inactive state indication indicating that the UE is to enter the inactive state.

Some examples of the method, network entities, and non-transitory computer-readable medium described herein may further include operations, features, means, or instructions for outputting, in accordance with obtaining the inactive state indication, fourth control signaling confirming that the UE may be permitted to enter the inactive state.

Some examples of the method, network entities, and non-transitory computer-readable medium described herein may further include operations, features, means, or instructions for outputting fifth control signaling indicating for the UE to refrain from entering the inactive state until output of the fourth control signaling, where outputting the fourth control signaling may be in accordance with outputting the fifth control signaling.

In some examples of the method, network entities, and non-transitory computer-readable medium described herein, the fourth control signaling includes an indication of a power state of the UE while in the inactive state, a duration associated with operating in the inactive state, or both.

In some examples of the method, network entities, and non-transitory computer-readable medium described herein, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples of the method, network entities, and non-transitory computer-readable medium described herein, the fourth control signaling indicates a second DRX cycle of the set of multiple DRX cycles in which the UE may be to enter the active state from the inactive state.

Some examples of the method, network entities, and non-transitory computer-readable medium described herein may further include operations, features, means, or instructions for outputting fourth control signaling including assistance information associated with an artificial intelligence model at the UE, where obtaining the third control signaling may be in accordance with outputting the assistance information.

In some examples of the method, network entities, and non-transitory computer-readable medium described herein, the assistance information includes a periodicity metric associated with each communication flow between the UE and the network entity, a jitter metric associated with each communication flow between the UE and the network entity, a priority associated with each communication flow between the UE and the network entity, a PDSB associated with each communication flow between the UE and the network entity, a size of a downlink buffer at the network entity, or any combination thereof.

Some examples of the method, network entities, and non-transitory computer-readable medium described herein may further include operations, features, means, or instructions for outputting, in accordance with obtaining the third control signaling, fourth control signaling including feedback information associated with an artificial intelligence model at the UE.

In some examples of the method, network entities, and non-transitory computer-readable medium described herein, the feedback information includes a quantity of DCI messages missed by the UE while operating in the inactive state, a bitmap indicating one or more DCI messages of a set of multiple DCI messages that were missed by the UE while operating in the inactive state, or both.

In some examples of the method, network entities, and non-transitory computer-readable medium described herein, the feedback information indicates one or more data radio bearers that were included in one or more transport blocks that were missed by the UE while operating in the inactive state.

In some examples of the method, network entities, and non-transitory computer-readable medium described herein, the feedback information includes a quantity of packets missed by the UE while operating in the inactive state, a priority of each packet missed by the UE while operating in the inactive state, a source IP address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

In some examples of the method, network entities, and non-transitory computer-readable medium described herein, the first control signaling includes one or more key performance indicators associated with an accuracy of an artificial intelligence model at the UE.

In some examples of the method, network entities, and non-transitory computer-readable medium described herein, the one or more key performance indicators include a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

Some examples of the method, network entities, and non-transitory computer-readable medium described herein may further include operations, features, means, or instructions for outputting an indication of a duration from obtaining the third control signaling, where the UE may be permitted to enter the inactive state after the duration and communicating one or more message with the UE during the duration.

In some examples of the method, network entities, and non-transitory computer-readable medium described herein, the second control signaling further indicates a set of multiple durations associated with operating in the inactive state.

In some examples of the method, network entities, and non-transitory computer-readable medium described herein, each duration of the set of multiple durations includes a respective quantity of DRX cycles associated with operating in the inactive state, a respective quantity of subframes associated with operating in the inactive state, a respective quantity of slots associated with operating in the inactive state, or any combination thereof.

In some examples of the method, network entities, and non-transitory computer-readable medium described herein, the second control signaling further indicates a timer associated with obtaining the third control signaling and the method, apparatuses, and non-transitory computer-readable medium may include further operations, features, means, or instructions for obtaining the third control signaling in accordance with expiration of the timer, where the timer begins in accordance with output of the second control signaling.

In some examples of the method, network entities, and non-transitory computer-readable medium described herein, the second control signaling includes a downlink data indicator, a first value of the downlink data indicator indicates that the network entity may be to transmit one or more downlink signals, and a second value of the downlink data indicator indicates that the UE may be permitted to autonomously enter the inactive state for the one or more DRX cycles.

In some examples of the method, network entities, and non-transitory computer-readable medium described herein, the third control signaling includes an indication of a power state of the UE while operating in the inactive state, a duration associated with operating in the inactive state, or both.

In some examples of the method, network entities, and non-transitory computer-readable medium described herein, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples of the method, network entities, and non-transitory computer-readable medium described herein, the power state of the UE includes an idle DRX power mode, a connected DRX power mode, a short DRX power mode, or a long DRX power mode.

A method for wireless communications by a UE is described. The method may include receiving first control signaling indicating a set of multiple DRX cycles, where each DRX cycle of the set of multiple DRX cycles includes a respective first duration associated with an active state at the UE, a respective second duration associated with an inactive state at the UE, or both, transmitting second control signaling indicating status information of a set of applications operated by the UE, receiving third control signaling indicating for the UE to enter the inactive state in accordance with the status information of the set of applications operated by the UE, and entering the inactive state in accordance with receiving the third control signaling.

A UE for wireless communications is described. The UE may include one or more memories storing processor executable code, and one or more processors coupled with the one or more memories. The one or more processors may individually or collectively be operable to execute the code to cause the UE to receive first control signaling indicating a set of multiple DRX cycles, where each DRX cycle of the set of multiple DRX cycles includes a respective first duration associated with an active state at the UE, a respective second duration associated with an inactive state at the UE, or both, transmit second control signaling indicating status information of a set of applications operated by the UE, receive third control signaling indicating for the UE to enter the inactive state in accordance with the status information of the set of applications operated by the UE, and enter the inactive state in accordance with receiving the third control signaling.

Another UE for wireless communications is described. The UE may include means for receiving first control signaling indicating a set of multiple DRX cycles, where each DRX cycle of the set of multiple DRX cycles includes a respective first duration associated with an active state at the UE, a respective second duration associated with an inactive state at the UE, or both, means for transmitting second control signaling indicating status information of a set of applications operated by the UE, means for receiving third control signaling indicating for the UE to enter the inactive state in accordance with the status information of the set of applications operated by the UE, and means for entering the inactive state in accordance with receiving the third control signaling.

A non-transitory computer-readable medium storing code for wireless communications is described. The code may include instructions executable by one or more processors to receive first control signaling indicating a set of multiple DRX cycles, where each DRX cycle of the set of multiple DRX cycles includes a respective first duration associated with an active state at the UE, a respective second duration associated with an inactive state at the UE, or both, transmit second control signaling indicating status information of a set of applications operated by the UE, receive third control signaling indicating for the UE to enter the inactive state in accordance with the status information of the set of applications operated by the UE, and enter the inactive state in accordance with receiving the third control signaling.

In some examples of the method, UEs, and non-transitory computer-readable medium described herein, the status information includes an indication that a first subset of the set of applications may be associated with a first operational status and a second subset of the set of applications may be associated with a second operational status, the first operational status associated with increased power consumption at the UE relative to the second operational status, and indicating for the UE to enter the inactive state may be based on the indication of the first subset of the set of applications and the second subset of the set of applications.

In some examples of the method, UEs, and non-transitory computer-readable medium described herein, the status information includes an indication of a respective buffer status of each of the set of applications, and indicating for the UE to enter the inactive state may be based on the indication of the respective buffer status of each of the set of applications.

In some examples of the method, UEs, and non-transitory computer-readable medium described herein, the status information includes an indication of a respective traffic time arrival associated with each of the set of applications, and indicating for the UE to enter the inactive state may be based on the indication of the respective traffic time arrival of each of the set of applications.

In some examples of the method, UEs, and non-transitory computer-readable medium described herein, the status information includes an indication of a respective expected event associated with each of the set of applications, and indicating for the UE to enter the inactive state may be based on the indication of the respective expected event of each of the set of applications.

In some examples of the method, UEs, and non-transitory computer-readable medium described herein, the status information includes an indication of a respective traffic priority associated with each of the set of applications, and indicating for the UE to enter the inactive state may be based on the indication of the respective traffic priority of each of the set of applications.

In some examples of the method, UEs, and non-transitory computer-readable medium described herein, the third control signaling further indicates a duration associated with operating in the inactive state and the duration includes a quantity of DRX cycles associated with operating in the inactive state, a quantity of subframes associated with operating in the inactive state, a quantity of slots associated with operating in the inactive state, or any combination thereof.

By implementing the features described herein, one or more advantages may be obtained. For example, by transmitting the inactive state indication, thereby enabling the UE to autonomously enter the inactive state, the UE may improve power savings during periods of time with little to no traffic. Additionally, by communicating the second and third control signals, the UE and the network entity may improve coordination for or during DRX operations, which may improve a reliability of the communications between the UE and the network entity. By implementing the model, such as the AI or ML model, at the UE, the UE may be able to determine various parameters associated with autonomously entering the inactive state, thereby improving the efficiency of DRX communications, among other benefits.

In some other examples, by having the network entity indicate for the UE 115 to enter into the inactive state, the UE may improve power savings during periods of time with little to no traffic. Additionally, by having the network entity operate the AI or ML model, the UE may avoid operating the AI or ML model, thereby experiencing increased power savings during active operations. Further, by communicating the status information, the network entity and the UE may experience improved coordination, in addition to a more accurate output of the AI or ML model from the network entity, which may improve a reliability of the communications between the UE and the network entity, and save the UE power, among other benefits.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports autonomous discontinuous reception (DRX) cycles in wireless communications systems in accordance with one or more aspects of the present disclosure.

FIG. 2 shows an example of a wireless communications system that supports autonomous DRX cycles in wireless communications systems in accordance with one or more aspects of the present disclosure.

FIG. 3 shows an example of a process flow that supports autonomous DRX cycles in wireless communications systems in accordance with one or more aspects of the present disclosure.

FIG. 4 shows an example of a timing diagram that supports autonomous DRX cycles in wireless communications systems in accordance with one or more aspects of the present disclosure.

FIG. 5 shows an example of a process flow that supports autonomous DRX cycles in wireless communications systems in accordance with one or more aspects of the present disclosure.

FIGS. 6 and 7 show block diagrams of devices that support autonomous DRX cycles in wireless communications systems in accordance with one or more aspects of the present disclosure.

FIG. 8 shows a block diagram of a communications manager that supports autonomous DRX cycles in wireless communications systems in accordance with one or more aspects of the present disclosure.

FIG. 9 shows a diagram of a system including a device that supports autonomous DRX cycles in wireless communications systems in accordance with one or more aspects of the present disclosure.

FIGS. 10 and 11 show block diagrams of devices that support autonomous DRX cycles in wireless communications systems in accordance with one or more aspects of the present disclosure.

FIG. 12 shows a block diagram of a communications manager that supports autonomous DRX cycles in wireless communications systems in accordance with one or more aspects of the present disclosure.

FIG. 13 shows a diagram of a system including a device that supports autonomous DRX cycles in wireless communications systems in accordance with one or more aspects of the present disclosure.

FIGS. 14 through 17 show flowcharts illustrating methods that support autonomous DRX cycles in wireless communications systems in accordance with one or more aspects of the present disclosure.

### DETAILED DESCRIPTION

In some wireless communications systems, a user equipment (UE) may operate according to a discontinuous reception (DRX) cycle, in which the UE operates in an active state (e.g., radio resource control (RRC) connected state, active communication state) for a first duration (e.g., DRX on-duration) and an inactive state (e.g., RRC inactive state, RRC idle state, reduced power mode) for a second duration (e.g., DRX off-duration). While operating in the inactive state of the DRX cycle, the UE may refrain from receiving signals, which may reduce power consumption at the UE and improve battery life at the UE, among other advantages. To facilitate the DRX cycle, a network entity may indicate a DRX configuration (e.g., information related to one or more DRX cycles) to the UE, which may include one or more parameters associated with a DRX cycle, such as the first duration, the second duration, and/or various timers, among other examples. The UE may alternate in the DRX cycle between the active state and the inactive state according to the DRX configuration. In some cases, it may be beneficial for the UE to autonomously enter the inactive state, for example, in cases where the UE may not have data to be communicated but is otherwise operating in the active state. In such cases, however, because the DRX configuration is controlled by the network entity, the UE may not have the flexibility to autonomously enter the inactive state, thereby increasing power consumption at the UE and/or degrading user experience, among other disadvantages.

The techniques described herein enable the UE to autonomously enter an inactive state during a DRX cycle. For example, the UE may receive first control signaling (e.g., RRC signaling) that includes the DRX configuration (e.g., information related to one or more DRX cycles). The UE may, during an active state of the DRX cycle, receive second control signaling indicating that the UE is permitted to autonomously enter the inactive state for one or more DRX cycles. In such examples, based on (e.g., in response to) receiving the second control signaling, the UE may transmit third control signaling including an inactive state indication that indicates the UE is to enter the inactive state. In some examples, before transmitting the third control signaling, the UE may obtain (e.g., calculate, determine, identify) a model, such as an output of an artificial intelligence (AI) or machine learning (ML) model, that may be operated at the UE, where the output may indicate whether to autonomously enter the inactive state, indicate a duration of operating in the inactive state, and/or indicate a time to enter the inactive state, among other examples. In this way, the UE may transmit the third control signaling including the inactive state indication based on (e.g., according to) the output of the model, such as the AI or ML model. According to transmitting the third control signaling, the UE may enter the inactive state instead of the active state, thereby increasing power savings at the UE, among other benefits.

By transmitting the inactive state indication, thereby enabling the UE to autonomously enter the inactive state, the UE may improve power savings during periods of time with little to no traffic. Additionally, by communicating the second and third control signals, the UE and the network entity may improve coordination for or during DRX operations, which may improve a reliability of the communications between the UE and the network entity. By implementing the model, such as the AI or ML model, at the UE, the UE may be able to determine various parameters associated with autonomously entering the inactive state, thereby improving the efficiency of DRX communications, among other benefits.

Aspects of the disclosure are initially described in the context of wireless communications systems. Aspects of the disclosure are further described in the context of process flows and timing diagrams. Aspects of the disclosure are further illustrated by and described with reference to apparatus diagrams, system diagrams, and flowcharts that relate to autonomous DRX cycles in wireless communications systems.

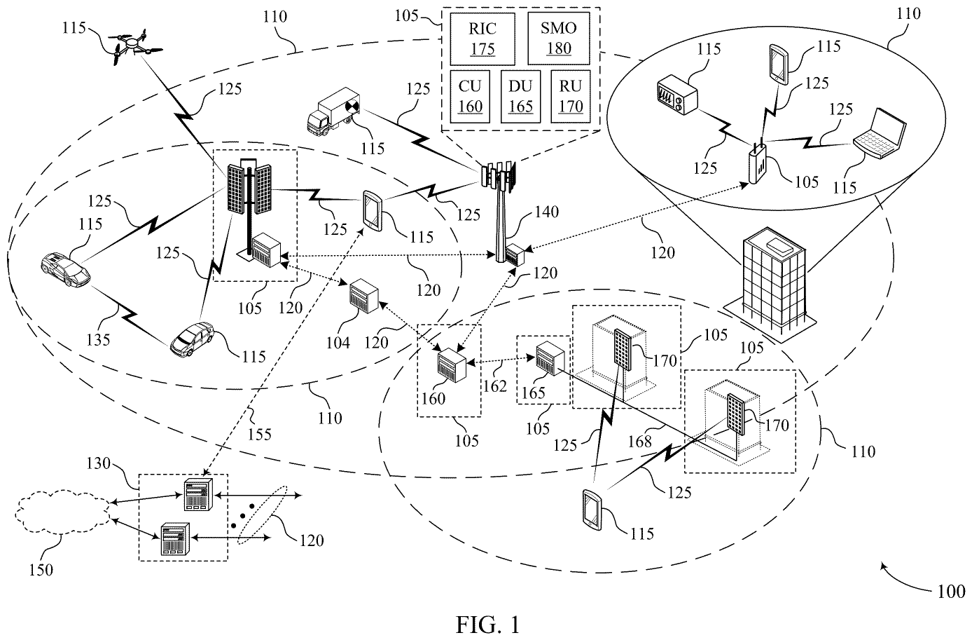

FIG. 1 shows an example of a wireless communications system 100 that supports autonomous DRX cycles in wireless communications systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long-Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support autonomous DRX cycles in wireless communications systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission-duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a UE 115 may operate according to a DRX cycle, in which the UE 115 operates in an active state (e.g., RRC connected state, active communication state) for a first duration (e.g., DRX on-duration) and an inactive state (e.g., RRC inactive state, RRC idle state, reduced power mode) for a second duration (e.g., DRX off-duration). Accordingly, while operating in the inactive state, the UE 115 may refrain from receiving signal, which may reduce power consumption at the UE 115, and improve battery life of the UE 115, among other advantages. To facilitate the DRX cycle, a network entity 105 may indicate a DRX configuration to the UE 115, which may include one or more parameters associated with the DRX cycle at the UE 115, such as the first duration, the second duration, or various timers, among other examples. As such, the UE 115 may alternate between the active state and the inactive state according to the DRX configuration. In some cases, it may be beneficial for the UE 115 to autonomously enter the inactive state, for example, in cases where the UE 115 may not have data to be communicated but is operating in the active state. In such cases, however, because the DRX configuration is controlled by the network entity 105, the UE 115 may not have the flexibility to autonomously enter the inactive state, thereby increasing power consumption at the UE 115, degrading user experience, among other disadvantages.

The techniques described herein may enable the UE 115 to autonomously enter the inactive state, which may improve power savings at the UE 115, and improve the efficiency of DRX cycles at the UE 115, among other advantages. For example, the UE 115 may receive first control signaling (e.g., RRC) that includes the DRX configuration. The UE 115 may, during an active state of a first DRX cycle, receive second control signaling (e.g., RRC signaling, downlink control information (DCI), a MAC control element (MAC-CE)) indicating that the UE 115 is permitted to autonomously enter the inactive state for one or more DRX cycles. In such examples, based on (e.g., in response to) receiving the second control signaling, the UE 115 may transmit third control signaling (e.g., RRC signaling, uplink control information (UCI), MAC-CE) that includes an inactive state indication that indicates the UE 115 is to enter the inactive state. In some examples, before transmitting the third control signaling, the UE 115 may obtain (e.g., calculate, determine, identify) an output of an AI or ML model operated at the UE 115, where the output may indicate whether to autonomously enter the inactive state, a duration of operating in the inactive state, or indicate a time to enter the inactive state, among other examples. In this way, the UE 115 may transmit the third control signaling including the inactive state indication based on (e.g., according to) the output of the AI or ML model. As such, based on transmitting the third control signaling, the UE 115 may enter the inactive state, thereby increasing power savings at the UE 115.

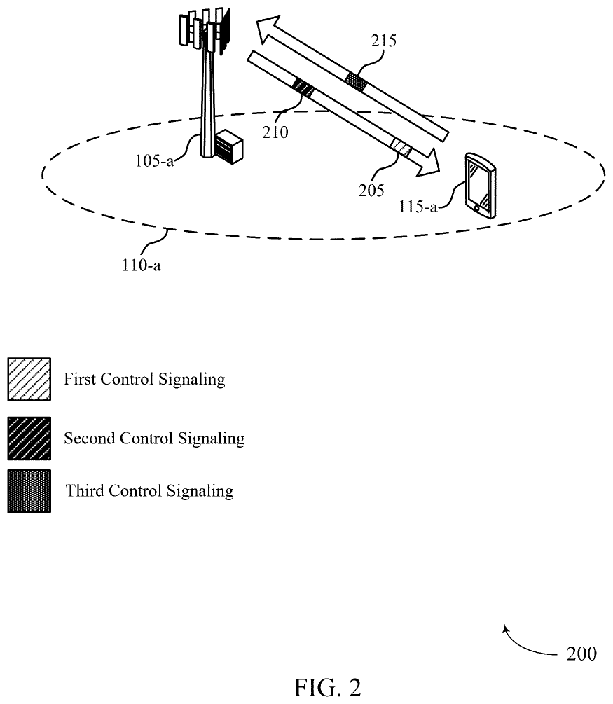

FIG. 2 shows an example of a wireless communications system 200 that supports autonomous DRX cycles in wireless communications systems in accordance with one or more aspects of the present disclosure. Aspects of the wireless communications system may implement, or be implemented by, aspects of the wireless communications system 100. For example, the wireless communications system 200 may include a UE 115-a communicating with a network entity 105-a within a coverage area 110-a, where the UE 115-a and the network entity 105-a may be examples of corresponding devices described herein with reference to FIG. 1. The techniques described in the context of the wireless communications system 200 may enable the UE 115-a to autonomously enter an inactive state during one or more DRX cycles.

For example, the wireless communications system 200 may implement multiple DRX cycles over time to reduce power consumption and save energy at the UE 115-a. A DRX cycle may include a first duration (e.g., DRX on-duration) associated with an active state (e.g., RRC connected state) at the UE 115-a and a second duration (e.g., off-duration) associated with an inactive state (e.g., RRC idle state or RRC inactive state) at the UE 115-a, where the inactive state may be associated with reduced power consumption at the UE 115-a relative to the active state. Accordingly, while operating in the active state, the UE 115-a may receive signals from the network entity 105-a. Alternatively, while operating in the inactive state, the UE 115-a may refrain from receiving signals from the network entity 105-a, thereby reducing power consumption.

To facilitate DRX cycles, the network entity 105-a may indicate a DRX configuration to the UE 115-a, which may include one or more parameters associated with the DRX cycles at the UE 115-a, such as the first duration (e.g., DRX on-durations), the second duration (e.g., DRX off-duration), or various timers (e.g., DRX inactivity timers, DRX cycle timers), among other examples. In some cases, it may be beneficial for the UE 115-a to autonomously enter the inactive state, for example, in cases where the UE 115-a may not have data to be communicated but is operating in the active state. In such cases, however, because the DRX configuration is controlled by the network entity 105-a and the values of the various parameters indicated via the DRX configuration are fixed, the UE 115-a may not have the flexibility to autonomously enter the inactive state, thereby increasing power consumption at the UE 115-a and degrading user experience, among other disadvantages.

The techniques described herein may enable the UE 115-a to autonomously enter the inactive state, thereby achieving increased power savings at the UE 115-a. In some examples, the UE 115-a may utilize one or more AI or ML models in addition to information gathered from applications operated at the UE 115-a to assist in autonomously entering the inactive state, which may improve power savings at the UE 115-a and increase efficiency of the DRX cycles, among other advantages.

For example, because the UE 115-a may have an indication of the status (e.g., video stream buffering, expective next traffic arrival time) of each application operated at the UE 115-a, the UE 115-a may utilize the status of each application in combination with the AI or ML model to determine whether to enter the inactive state. Additionally, because the UE 115-a may have an improved indication of user activity relative to the network entity 105-a, the UE 115-a may utilize the user activity (e.g., front running applications versus background running applications) in combination with the AI or ML model to determine whether to enter the inactive state. Similarly, because the UE 115-a may learn the behavior pattern of the user (e.g., expected next user activity), the UE 115-a may utilize the behavior pattern of the user in combination with the AI or ML model to determine whether to enter the inactive state. Likewise, because power savings at the UE 115-a may be different from UE to UE (e.g., up to UE implementation, such as having one of or all of a micro sleep mode, a light sleep mode, a deep sleep mode), the UE 115-a may utilize the operational parameters at the UE 115-a in combination with the AI or ML model to determine whether to enter the inactive state.

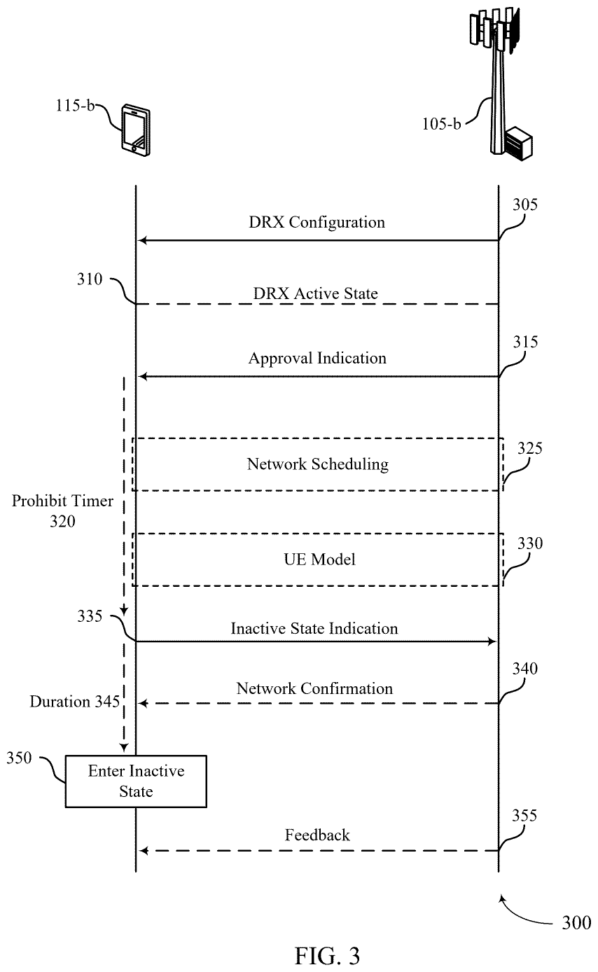

Accordingly, to enable the UE 115-a to autonomously enter the inactive state, the UE 115-a and the network entity 105-a may implement one or more signaling techniques. For example, the network entity 105-a may transmit first control signaling 205 (e.g., RRC signaling) indicating the DRX configuration to the UE 115-a, where the DRX configuration may configure the UE 115-a with multiple DRX cycles. In some examples, the network entity 105-a may also indicate, via the first control signaling, one or more key performance indicators associated with the AI or ML model operated at the UE 115-a, such that the UE 115-a may utilize the one or more key performance indicators to update the AI or ML model (e.g., adjust weights of the AI or ML model to meet the key performance indicators). Such techniques may be further described herein with reference to the operations at 305 of FIG. 3. In response to receiving the first control signaling 205, the UE 115-a may operate according to the DRX configuration. For example, the UE 115-a may alternate (e.g., cycle) between the active states and the inactive states according to the DRX configuration.

Accordingly, while operating in the active state of a first DRX cycle, the UE 115-a may receive, from the network entity 105-a, second control signaling 210 (e.g., RRC signaling, DCI, MAC-CE) indicating whether the UE 115-a is permitted to enter the inactive state for one or more DRX cycles. For example, the network entity 105-a may indicate, via the second control signaling 210, whether the UE 115-a is permitted to transmit an inactive state indication during the current DRX cycle. In some examples, if the network entity 105-a indicates that the UE 115-a is permitted to autonomously enter the inactive state, the network entity 105-a may indicate a prohibition timer via the second control signaling 210, where the prohibition timer may indicate when the UE 115-a is permitted to transmit the inactive state indication. Such techniques may be further described herein with reference to the operations at 315 of FIG. 3.

In response to receiving approval from the network entity 105-a (e.g., via the second control signaling), the UE 115-a may utilize the one or more AI or ML models to determine whether to enter the inactive state, determine a duration associated with operating in the inactive state, and/or determine when to enter the inactive state, among other examples. Such techniques may be further described herein with reference to the operations at 330 of FIG. 3. As such, based on an output of the one or more AI or ML models, the UE 115-a may transmit third control signaling (e.g., RRC signaling, UCI, MAC-CE) to the network entity 105-a that includes the inactive state indication indicating that the UE is to enter the inactive state. In some examples, in addition to the inactive state indication, the UE 115-a may also transmit, via the third control signaling, the duration associated with operating in the inactive state, an indication of which on-duration (e.g., DRX cycle) the UE is to return to the active state. Such techniques may be further described herein with reference to the operations at 335 of FIG. 3.

In some examples, the UE 115-a may operate according to a first mode of operation (e.g., UE autonomous mode), in which the UE 115-a enters the inactive state in response to transmitting the third control signaling 215 and without a confirmation from the network entity 105-a. For example, while operating in the first mode of operation, the UE 115-a may enter the inactive state in response to transmitting the inactive state indication via the third control signaling 215.

In some other examples, the UE 115-a may operate according to a second mode of operation (e.g., UE request mode), in which the UE 115-a enters the inactive state in response to network confirmation of the inactive state indication. For example, while operating in the second mode of operation, the UE 115-a may transmit the third control signaling 215 including the inactive state indication and the UE 115-a may receive, from the network entity 105-a, fourth control signaling (e.g., RRC signaling, MAC-CE, DCI) confirming that the UE 115-a is permitted to enter the inactive state. Accordingly, in response to receiving the fourth control signaling, the UE 115-a may enter the inactive state. In such examples, the network entity 105-a may indicate, via the fourth control signaling, which DRX on-duration the UE 115-a is to return to the active state. Such techniques may be further described herein with reference to the operations at 340 of FIG. 3.

The UE 115-a may operate in the inactive state and may return to the active state after a duration. In some examples, in response to the UE 115-a returning to the active state, the network entity 105-a may transmit fifth control signaling (e.g., RRC signaling, DCI, MAC-CE) indicating feedback information for the one or more AI or ML models operated by the UE 115-a. In such examples, the UE 115-a may utilize the feedback information to update the one or more AI or ML models at the UE 115-a, such that the UE 115-a may obtain a more accurate and efficient output of the one or more AI or ML models. Such techniques may be further described herein with reference to the operations at 355 of FIG. 3.

FIG. 3 shows an example of a process flow 300 that supports autonomous DRX cycles in wireless communications systems in accordance with one or more aspects of the present disclosure. Aspects of the process flow 300 may be implemented by aspects of the wireless communications system 100 and the wireless communications system 200, as described herein with reference to FIGS. 1 and 2. For example, aspects of the process flow 300 may be implemented by a network entity 105-b and a UE 115-b, which may be examples of corresponding devices, as described herein with reference to FIGS. 1 and 2. The techniques described in the context of the process flow 300 may enable the UE to autonomously enter an inactive state.

For example, at 305, the network entity 105-b may transmit first control signaling (e.g., the first control signaling 205, RRC signaling, DCI, MAC-CE) indicating a DRX configuration for the UE 115-b. For example, the network entity 105-b may indicate, via the DRX configuration, a pattern for cycling between the active state and the inactive state. To do so, the network entity 105-b may indicate, via the DRX configuration, a DRX on-duration associated with the UE 115-b operating within the active state, a DRX off-duration associated with the UE 115-b operating within the inactive state, a periodicity of the DRX on-durations, a periodicity of the DRX off-durations, or any combination thereof.

In some examples, the network entity 105-b may also indicate, via the first control signaling, one or more key performance indicators associated with one or more AI or ML models at the UE 115-b. For example, as described herein, the UE 115-b may maintain and utilize one or more AI or ML models to autonomously enter the inactive state during the DRX cycles. Accordingly, the network entity 105-b may indicate the one or more key performance indicators, where the UE 115-b may update the one or more AI or ML models, such that an output of the one or more AI or ML models satisfies (e.g., reach, obtain, meet) the one or more key performance indicators. That is, the UE 115-b may utilize the one or more key performance indicators to improve (e.g., increase, tailor) an accuracy of the one or more AI or ML models.

In such examples, the one or more key performance indicators may include a target (e.g., threshold) time window associated with the UE 115-b operating within the inactive state, which may be defined in milliseconds (ms), a quantity of slots, a quantity of subframes, a quantity of DRX cycles, a quantity of DRX on-durations, or any combination thereof. As an illustrative example, the network entity 105-b my indicate a target time window of 30 ms for the UE 115-b to operate in the inactive sate. Accordingly, the UE 115-b may update (e.g., train) the one or more AI or ML models to ensure the AI or ML models output a duration for operating in the inactive state that is less than or equal to the target time window of 30 ms.

In some examples, the one or more key performance indicators may include a target (e.g., threshold) quantity of missing packets while the UE 115-b is operating in the inactive state. As an illustrative example, the network entity 105-b may indicate a target quantity of missing packets of 10, such that the UE 115-b may update (e.g., train) the one or more AI or ML models to ensure the AI or ML models output a duration for operating in the inactive state or a time for entering the inactive state that reduces the quantity of missed packets at the UE 115-b.

Similarly, the one or more key performance indicators may include a target (e.g., threshold) percentage of missing packets while the UE 115-b is operating in the inactive state. In such examples, the percentage of missing packets may be relative to a quantity of packets received by the UE 115-b during single DRX on-duration cycle. For example, while operating in the active state during the DRX on-duration, the UE 115-b may, on average, receive 100 packets. Accordingly, the target percentage of missing packets may be associated with a percentage of the 100 packets received by the UE 115-b. Accordingly, as an illustrative example, the network entity 105-b may indicate a target percentage of missing packets of 15%, such that the UE 115-b may update (e.g., train) the one or more AI or ML models to ensure the AI or ML models output a duration for operating in the inactive state or a time for entering the inactive state that reduces the quantity of missed packets at the UE 115-b. In such examples, the one or more key performance indicators may be per data radio bearer at the UE 115-b.

In response to receiving the one or more key performance indicators, the UE 115-b may update the AI or ML models accordingly. To update the one or more AI or ML models, the UE 115-b may perform additional training on feedback information obtained from previous DRX cycles, which may be provided to the UE 115-b from the network entity 105-b or generated by the UE 115-b, using the one or more key performance indicators, or both. For example, the UE 115-b may adjust various parameters (e.g., weights) of the one or more AI or ML models based on the feedback information, the one or more key performance indicators, or both, thereby ensuring that an output of the one or more AI or ML models at least accounts for the one or more key performance indicators. Such feedback information may be further described herein with reference to the operations at 355.

At 310, the UE 115-b may operate according to the DRX configuration. For example, the UE 115-b may enter an active for the DRX on-duration during a first DRX cycle. At 315, the network entity 105-b may transmit second control signaling (e.g., RRC signaling, DCI, MAC-CE) indicating that the UE 115-b is permitted to enter the inactive state for one or more DRX cycles. In such examples, the network entity 105-b may determine whether to approve the UE 115-b to enter the inactive state based on traffic patterns between the UE 115-b and the network entity 105-b, whether new data is scheduled from the UE 115-b, on information (e.g., battery life, processing power, among other examples) received from the UE, or a combination thereof. By transmitting the approval indication via the second control signaling, the network entity 105-b may maintain some control over whether the UE 115-b enters the inactive state, while also providing flexibility to the UE 115-b.

In some examples, the network entity 105-b indicate, via the second control signaling, whether the UE 115-b is permitted (e.g., approved) to enter the inactive state for the current DRX cycle, where such permission (e.g., approval) may be valid until a start of a next DRX on-duration. For example, the UE 115-b may receive the second control signaling within a DRX on-duration of a first DRX cycle indicating that the UE 115-b is permitted to enter the inactive state. Accordingly, the UE 115-b may be permitted to enter the inactive state for the rest of the DRX on-duration but may return the active state for the DRX on-duration of a second DRX cycle that is immediately after the first DRX cycle.

In some other examples, the network entity 105-b may indicate, via the second control signaling and in addition to the approval indication, an allowed range of a duration associated with the UE 115-b operating within the inactive state, where the range may be defined in ms, a quantity of subframes, a quantity of slots, a quantity of DRX cycles, or any combination thereof. In one example, the network entity 105-b may indicate multiple durations associated with the UE 115-b operating in the inactive state, such that the UE 115-b may select one of the multiple durations. As an illustrative example, the network entity 105-b may indicate a first allowed duration (e.g., 10 ms), a second allowed duration (e.g., 15 ms), and/or a third allowed duration (e.g., 18 ms, among other examples. Additionally, or alternatively, the network entity 105-b may indicate a threshold range associated with operating in the inactive state. As an illustrative example, the network entity 105-b may indicate an allowed range of 1 slot to 5 slots associated with the UE 115-b operating within the inactive state, such that the UE 115-b may select a duration for operating in the inactive state between 1 slot and 5 slots).

In addition to the approval indication, the durations associated with operating in the inactive state, or both, the network entity 105-b may also indicate, via the second control signaling, a value of a prohibit timer 320, where the value of the prohibit timer 320 may be defined in ms, a quantity of subframes, a quantity of slots, a quantity of DRX on-durations, among other examples. In such examples, the prohibit timer 320 may indicate how early, from reception of the second control signaling at 315, the UE 115-b is permitted to transmit the inactive state indication at 335. Accordingly, if the value of the prohibit timer 320 is set in the second control signaling, the UE 115-b may start the prohibit timer 320 (e.g., DRX timer) in response to reception of the second control signaling at 315, such that the UE 115-b may transmit the inactive state indication after expiration of the prohibit timer 320. Alternatively, if the value of the prohibit timer 320 is not set in the second control signaling, the UE 115-b may transmit the inactive state indication in response to receiving the second control signaling (e.g., DCI) from the network entity 105-b. As an illustrative example, the network entity 105-b may indicate a value of the prohibit timer 320 to be 4 ms. Accordingly, the UE 115-b may transmit the inactive state indication at 330 after 4 ms from receiving the second control signaling at 315.

In such examples, if the UE 115-b misses the second control signaling (e.g., does not receive or correctly decode the second control signaling), the UE 115-b may refrain from entering the inactive state and await reception of the second control signaling in a second DRX cycle.

In some examples, the second control signaling may be a DCI. Accordingly, the network entity 105-b may indicate that the UE 115-b is permitted to enter the inactive state via a scheduling DCI (e.g., physical downlink shared channel (PDSCH) or physical uplink shared channel (PUSCH) scheduling DCI) or any one of multiple DCI formats (e.g., group DCI format, dedicated DCI format, among other examples).

In some examples, the approval indication may correspond to a new data indicator (NDI) bit field within a DCI message. That is, a NDI bit field may be interpreted as whether the UE 115-b is permitted to enter the inactive state. For example, the second control signaling may be a scheduling DCI, where the network entity 105-b may indicate, via the NDI bit field (e.g., 1 bit), whether new downlink data is scheduled to be transmitted during the current DRX cycle (e.g., during the current on-duration). Accordingly, the UE 115-b may utilize the NDI bit field to determine whether to enter the inactive state (while also considering the uplink traffic at the UE 115-b). In such examples, the scheduling DCI may include various DRX timers (e.g., on-duration timer, inactive timer, among other examples) or may not include the DRX timers.

As an illustrative example, if the value of the NDI bit field of the scheduling DCI (e.g., second control signaling) indicates that the network entity 105-b has downlink data for the UE 115-b, the UE 115-b may determine that the UE 115-b is not permitted to enter the inactive sate. Alternatively, if the value of the NDI bit field of the scheduling DCI (e.g., second control signaling) indicates that the network entity 105-b does not have downlink data for the UE 115-b, the UE 115-b may determine that the UE 115-b is permitted to enter the inactive sate.

At 325, the network entity 105-b may perform network scheduling and communicate uplink or downlink traffic with the UE 115-b. For example, if, at 315, the network entity 105-b indicates a value for the prohibit timer 320, then the network entity 105-b may schedule uplink communications, downlink communications, or both with the UE 115-b while the prohibit timer is running. In this way, the network entity 105-b may still communicate with the UE 115-b before the UE 115-b entering the inactive state.

At 330, in response to being permitted to enter the inactive state at 315, the UE 115-b may obtain an output of the one or more AI or ML models to determine whether to autonomously enter the inactive state. That is, based on user specific conditions (e.g., whether applications are foreground or background operations, video buffering status, among other examples) and UE-specific implementations (e.g., cycles for UE sleep modes), the UE 115-b may determine, using the one or more AI or ML models, a timing to enter the inactive state, a power state the UE 115-b is to use while operating in the inactive state, a duration associated with operating in the inactive state, or any combination thereof.

For example, the UE 115-b may provide one or more inputs to the one or more AI or ML models, where the output of the one or more AI or ML models may indicate the timing to enter the inactive state, the power state the UE 115-b is to use while operating in the inactive state, the duration associated with operating in the inactive state, or any combination thereof.

In such examples, the one or more inputs may include an indication of which applications are foreground applications (e.g., actively being operated at the UE 115-b), an indication of which applications are background applications (e.g., not actively being operated at the UE 115-b). As an illustrative example, the user of the UE 115-b may be operating a web-browser as a foreground application. Accordingly, if the user of the UE 115-b continues to utilize the browser (e.g., activates a link of website to load the website), the UE 115-b may determine, via an output of the AI or ML models, to enter the inactive state for a relatively increased duration while the user is browsing the website. In such examples, the one or more AI or ML models may be utilized to predict the users behavior and website contents, such that the UE 115-b may determine whether to enter the inactive state.

As another illustrative example, if the user of the UE 115-b is operating a video platform as a foreground application and if the video data is sufficiently buffered, the UE 115-b may determine, via the one or more AI or ML models, to enter the inactive state for a relatively increased duration. Similarly, if multiple applications are running in a background of the UE 115-b and are not associated latency sensitive communications, the UE 115-b may determine, via the one or more AI or ML models, to enter the inactive state for a relatively increased duration.

In some other examples, the one or more inputs to the one or more AI or ML models may include information associated with power of the UE 115-b, such as a battery life of the UE 115-b, a user configuration associated with power at the UE 115-b, or both. Accordingly, the UE 115-b may input such information into the one or more AI or ML models, where the one or more AI or ML models may provide the output based on the information associated with the power of the UE 115-b.

In some examples, the one or more inputs to the one or more AI or ML models may include downlink communication parameters, such as a packet delay budget (PDB) of each communication flow between the UE 115-b and the network entity 105-b, a packet data unit set delay budget (PDSB) of each communication flow between the UE 115-b and the network entity 105-b, a priority (e.g., importance or urgence) of each communication flow between the UE 115-b and the network entity 105-b, a latency of each communication flow between the UE 115-b and the network entity 105-b, a packet data unit (PDU) set completion rate of each communication flow between the UE 115-b and the network entity 105-b, or any combination thereof. Accordingly, the UE 115-b may input one or more of the downlink communication parameters into the one or more AI or ML models, where the one or more AI or ML models may provide the output based on the downlink communication parameters.

Additionally, the one or more inputs to the one or more AI or ML models may include uplink communication parameters, such as an uplink traffic buffer at the UE 115-b, predicted uplink traffic at the UE 115-b, or both. Accordingly, the UE 115-b may input one or more of the uplink communication parameters into the one or more AI or ML models, where the one or more AI or ML models may provide the output based on the uplink communication parameters. The one or more inputs may also include an indication of an on-duration of a subsequent DRX cycle, an indication of one or more mandatory slots for communication, one or more sleep modes (e.g., deep sleep mode, light sleep mode, micro sleep mode) at the UE 115-b, or a combination thereof. Accordingly, the UE 115-b may input such information into the one or more AI or ML models, where the one or more AI or ML models may provide the output based on such information.

In some examples, the network entity 105-b may transmit assistance information to the UE 115-b, where the assistance information may include one or more inputs to the one or more AI or ML models at the UE 115-b. The network entity 105-b may transmit the assistance information with the first control signaling at 305, in response to transmitting the first control signaling, during the network scheduling at 325, or any combination thereof.

In such examples, the assistance information may include an indication of a traffic pattern of each communication flow (e.g., a quantity of uplink data communicated over each communication flow, a quantity of downlink data communicated over each communication flow, or both), a periodicity of traffic for each communication flow (e.g., how frequently data for each communication flow may be communicated), a jitter metric of each communication flow (e.g., a variation in communication time for packets communicated over each communication flow), a quality of service (QoS) metric per communication flow (e.g., one or more threshold metrics communications over each communication flow are to satisfy), a priority of each communication flow (e.g., an importance of each communication flow relative to other communication flows), a PSDB per communication flow (e.g., a latency metric per communication flow), a downlink buffer size of the network entity 105-b (e.g., a quantity of downlink data to be scheduled and transmitted to the UE 115-b), or any combination thereof. Accordingly, the UE 115-b may input the one or more inputs included in the assistance information into the one or more AI or ML models, where the AI or ML models may provide the output.

In some examples, the UE 115-b may obtain, at a modem of the UE 115-b, the one or more inputs from applications operated at the UE 115-b, from the operating system running at an application processor of the UE 115-b, or both. That is, the applications operated at the UE 115-b and/or the application processor may provide the one or more inputs to the modem of the UE 115-b, where the modem of the UE 115-b may provide the one or more inputs (e.g., buffer status, indication of foreground and background operations, traffic patterns of the applications, latency metrics for each application, next events for each application, IP addresses associated with each application, port numbers associated with each application, network protocols associated with each application, such as transmission control protocols (TCP), user datagram protocols (UDP), quick UDP internet connection (QUIC), real-time transport protocols (RTP), or hypertext transfer protocol (HTTP)) to the AI or ML model. Additionally, as described herein, the network entity 105-b may transmit such assistance information to the UE 115-b, where the assistance information may be used as inputs to the AI or ML models at the UE 115-b.

Additionally, the modem of the UE 115-b may obtain the current airlink channel conditions, where such airlink channel conditions may include a rank used for communications via the channel, a modulation and coding scheme used for communications via the channel, a throughput of the channel, or any combination thereof. Accordingly, the modem of the UE 115-b may provide the current airlink channel conditions to the AI or ML model. The AI or ML model may utilize the one or more inputs and the current airlink channel conditions to calculate whether the UE 115-b should enter the inactive state, calculate a time for entering the inactive state, a duration for entering the inactive state, and the power state of the UE 115-b while operating in the inactive state.

For example, as part of the AI or ML model, the modem of the UE 115-b may perform a series of computations to produce a result, where such computations may involve matrix multiplications, convolutions, or other mathematical operations. In response to performing the series of computations, the modem of the UE 115-b may transform the result into the output (e.g., time for entering the inactive state, a duration for entering the inactive state, and the power state of the UE 115-b while operating in the inactive state), for example, by converting numeric scores into specific parameters, or applying a threshold to a probability.

As an illustrative example, if a video streaming application operated at the UE 115-b reports the buffer status to the modem of the UE 115-b, the modem of the UE 115-b may estimate (via the AI or ML models) or be informed of a quantity of time remaining until the buffer becomes empty and estimate a time at which the video streaming application may request to send subsequent data to fill the buffer. According to the estimated quantity of time and the estimated time, the modem of the UE 115-b, via the AI or ML model, may determine a duration for a long DRX cycle to improve power savings at the UE 115-b.

At 335, according to the output obtained at 330, the UE 115-b may transmit third control signaling (e.g., RRC signaling, UCI, MAC-CE) that includes the inactive state indication indicating whether the UE 115-b is to enter the inactive state. For example, if the output from the AI or ML models at 330 indicates for the UE 115-b to enter the inactive state, the UE 115-b may transmit the third control signaling indicating that the UE 115-b is to enter the inactive state. Alternatively, if the output from the AI or ML models at 330 indicates for the UE 115-b to remain in the active state for a remainder of the on-duration of the current DRX cycle, the UE 115-b may refrain from transmitting the third control signaling or may transmit the third control signaling indicating that the UE 115-b is to remain in the active state.

In some examples, in addition to indicating that inactive state indication, the UE 115-b may also indicate, via the third control signaling, the power state of the UE 115-b while operating in the inactive state, where the power state may be output from (e.g., determined using) the AI or ML models at 330. For example, the UE 115-b may indicate whether the UE 115-b is to operate in an idle mode DRX power state, a connected mode DRX power state (C-DRX), a short DRX power state (e.g., a duration associated with operating in the inactive state is reduced relative to other power states), a long DRX power state (e.g., a duration associated with operating in the inactive state is increased relative to other power states), or a combination of power states.

Additionally, the UE 115-b may indicate, via the third control signaling, a duration associated with operating in the inactive state, where the duration may be defined in ms, a quantity of subframes, a quantity of slots, a quantity of DRX cycles, a quantity of DRX on-durations, or any combination thereof. As described herein, the duration associated with operating in the inactive state may be output from (e.g., determined using) the one or more AI or ML models at 330. For example, if the UE 115-b determines to use the C-DRX power state, the UE 115-b may also indicate the duration associated with operating in the inactive state.

In some examples, the UE 115-b may operate according to a first mode of operation (e.g., autonomous mode) or a second mode of operation (e.g., UE request mode). That is, at 305 (e.g., via the first control signaling), at 315 (e.g., via the second control signaling), or during 325 (e.g., via some other control signaling), the network entity 105-b may indicate for the UE 115-b to operate according to the first mode of operation or the second mode of operation.

In the first mode of operation, the UE 115-b may enter the inactive state in response to transmitting the inactive state indication at 335 and without a confirmation message from the network entity 105-b, which may improve power savings performance at the UE 115-b (due to the UE 115-b being able to enter the inactive state in response to transmitting the inactive state indication). Thus, as an illustrative example, while operating in the first mode of operation, the UE 115-b may transmit the inactive state indication at 335 and may proceed to operations at 350, where the UE 115-b may enter the inactive state.

In some examples, if the network entity 105-b indicates for the UE 115-b to operate according to the first mode of operation, the UE 115-b may enter the inactive state at 350 after a duration 345 (e.g., after a fixed time) from transmission of the third control signaling at 335. For example, the duration 345 may be set at 5 ms. Accordingly, the UE 115-b may wait, while operating in the first mode of operation, to enter the inactive state after 5 ms from transmitting the inactive state indication at 335. In such examples, the duration 345 may be predefined, dynamic, semi-static, or configured by the network entity 105-b via control signaling, among other examples. As such, in some cases, during the duration 345, the network entity 105-b may transmit pending data to the UE 115-b, in the case that any additional data is to be delivered to the UE 115-b.

Alternatively, at 340, if the network entity 105-b indicates for the UE 115-b to operate according to the second mode of operation, the UE 115-b may refrain from entering the inactive state 350 until reception of a confirmation message. For example, at 340, in response to transmitting the third control signaling at 335, the UE 115-b may monitor for and receive fourth control signaling (e.g., DCI, RRC signaling, MAC-CE) confirming that the UE 115-b can enter the inactive state. In such examples, the network entity 105-b may indicate, via the fourth control signaling, the duration associated with operating in the inactive state, which may be based on the duration indicated from the UE 115-b to the network entity 105-b at 335. In such examples, the duration may be defined in ms, a quantity of subframes, a quantity of slots, a quantity of DRX cycles, a quantity of DRX on-durations, or any combination thereof. Similarly, the network entity 105-b may indicate, via the fourth control signaling, the power state the UE 115-b is to operate within while in the inactive state, which may be based on the power state indicated from the UE 115-b to the network entity 105-b at 335

At 350, the UE 115-b may enter the inactive state according to the information received at 315, determined at 330, transmitted at 335, and/or received at 340. For example, the UE 115-b may enter the inactive state for the duration indicated from the network entity 105-b at 315 or at 340 and operate using the power state indicated from the network entity 105-b at 315 or at 340. Similarly, the UE 15-b may enter the inactive state for the duration indicated via the third control signaling at 335 and operate using the power state indicated via the third control signaling at 335.

At 355, the UE 115-b may receive feedback information including one or more statistics regarding traffic patterns while the UE 115-b was operating within the inactive state in response to returning to the active state. For example, while the UE 115-b is operating in the inactive state, the network entity 105-b may gather the feedback information for the UE 115-b, such that the UE 115-b may utilize the feedback information to update one or more AI or ML models, thereby improving the accuracy of the output of the one or more AI or ML models.

In such examples, the feedback information may include an indication of which DCIs were missed while the UE 115-b was operating in the inactive state. For example, the network entity 105-b may indicate a bitmap to the UE 115-b, where each bit may correspond to a respective DCI message that was transmitted during one or more DRX cycles. Accordingly, the UE 115-b may identify which DCI messages the UE 115-b missed while operating in the inactive state. Additionally, or alternatively, the network entity 105-b may indicate a quantity of DCI messages missed by the UE 115-b while operating in the inactive state. Accordingly, the UE 115-b may utilize the indication of missing DCIs to update (e.g., train) the one or more AI or ML models. For example, the UE 115-b may determine which DCIs were missed to due to the output from the AI or ML models and update the AI or ML models accordingly.

The feedback information may also include an indication of which data radio bearers were included in respective transport blocks (e.g., packets) that were missed by the UE 115-b while operating in the inactive state, an indication of a quantity of packets (e.g., transport blocks) missed by the UE 115-b while operating in the inactive state, a priority (e.g., importance relative to other packets) of each packet missed by the UE 115-b while operating in the inactive state, an indication of a percentage of missed packets by the UE 115-b while operating in the inactive state (e.g., a percentage of missed packets out of a total quantity of packets scheduled for the UE 115-b during a time period of active and inactive durations), or any combination thereof. In some examples, the feedback information may include 5-tuple information for each missed packet. For example, the 5-tuple information may include source IP address of each packet missed by the UE 115-b while operating in the inactive state, a source port of each packet missed by the UE 115-b while operating in the inactive state, a destination IP address of each packet missed by the UE 115-b while operating in the inactive state, a destination port of each packet missed by the UE 115-b while operating in the inactive state, a transportation protocol of each packet missed by the UE 115-b while operating in the inactive state, or a combination thereof.

The UE 115-b may utilize such feedback information to update (e.g., train) the one or more AI or ML models. For example, the UE 115-b may maintain an AI or ML model per communication flow between the UE 115-b and the network entity 105-b. Accordingly, the UE 115-b may update each AI or ML model according to the feedback information associated with the respective communication flow. As an illustrative example, the UE 115-b may utilize a first AI model for a first communication flow. Thus, according to the feedback information for the first communication flow, the UE 115-b may update (e.g., train) the first AI model and utilize the first AI model for a subsequent inactive state decision.

In some examples, the UE 115-b may maintain AI or ML models per specific application (e.g., 5-tuple). Accordingly, the UE 115-b may update each AI or ML model according to the feedback information associated with the application. As an illustrative example, the UE 115-b may utilize a first AI model for a first application. Thus, according to the feedback information for the first application, the UE 115-b may update (e.g., train) the first AI model and utilize the first AI model for a subsequent inactive state decision.

As an illustrative example of updating the AI or ML models, the UE 115-b may perform a reinforcement learning procedure, in which the UE 115-b provides the feedback information to the AI or ML model, such that the AI or ML model may learn in an interactive environment by trial and error using the feedback information from the actions and experiences of the AI or ML model.

In some other examples, the network entity 105-b may configure an AI or ML model for use at the UE 115-b according to the feedback information. For example, the UE 115-b may receive, instead of the feedback information, weight parameters for each respective AI or ML model, such that the UE 115-b may implement such weight parameters for each respective AI or ML model without training the AI or ML models at the UE 115-b. In such examples, the network entity 105-b may utilize the feedback information, as described herein, to identify the updated weight parameters for each AI or ML model. In this way, the UE 115-b may refrain from updating the AI or ML model in favor of implementing the received weight parameters, thereby reducing power consumption at the UE 115-b.

In some other examples, the UE 115-b may receive, instead of the feedback information, one or more neural networks to utilize for the inactive state decision (e.g., one for each application or communication flow), where the UE 115-b may implement the one or more neural networks for the inactive state decision without updating the AI or ML models at the UE 115-b. In such examples, the network entity 105-b may utilize the feedback information, as described herein, to identify the neural networks. In this way, the UE 115-b may refrain from updating the AI or ML model in favor of implementing the one or more neural networks, thereby reducing power consumption at the UE 115-b.

As described herein, the UE 115-b may train, operate, and update one or more AI or ML models for use in determining to enter the inactive state. As an illustrative example of such a process, the UE 115-b may train a first AI or ML model using a data set, which may include traffic information (e.g., TBs communicated over a time period, DCIs communicated over a time period, a quantity of missing packets, a priority of missing packets, among other examples), downlink parameters (e.g., PDB, PDSB, latency metrics, PDU set completions, priority, among other examples), uplink parameters (e.g., uplink traffic buffers), UE sleep cycles (e.g., deep, light, micro sleep cycles), and power parameters (e.g., battery settings, battery life, user configurations), among other examples. In this way, the UE 115-b may obtain weights for use in the first AI or ML model.

Based on training the first AI or ML model, the UE 115-b may, during a first DRX cycle, utilize the first AI or ML model to obtain outputs, which my include a time to enter the inactive state, a sleep state to enter into while in the inactive state, a duration associated with entering the inactive state, among other examples. To obtain the output, the UE 115-b may provide the AI or ML model one or more inputs, which may include current downlink parameters experienced by the UE 115-b (e.g., PDB, PDSB, latency metrics, PDU set completions, priority, among other examples), current uplink parameters experienced by the UE 115-b (e.g., uplink traffic buffers or predicted uplink traffic buffers), current sleep cycles of the UE 115-b (e.g., deep, light, micro sleep cycles), and current power parameters of the UE 115-b (e.g., battery settings, battery life, user configurations), among other examples. In this way, the first AI or ML model my calculate the outputs using inputs similar to the data set used to train the first AI or ML model.

After obtaining the output, the UE 115-b may enter into the inactive state according to the output, as described herein. The UE 115-b may also update the first AI or ML model according to feedback information provided by the network entity 105-b, obtained by the UE 115-b, or both. In such examples, the feedback information may include traffic information (e.g., TBs communicated over a time period, DCIs communicated over a time period, a quantity of missing packets, a priority of missing packets, among other examples) obtained while the UE 115-b was operating in the inactive state. Accordingly, the UE 115-b may train the first AI or ML model on the feedback information, such that the first AI or ML model may be updated according to information similar to the data set used to train the first AI or ML model.

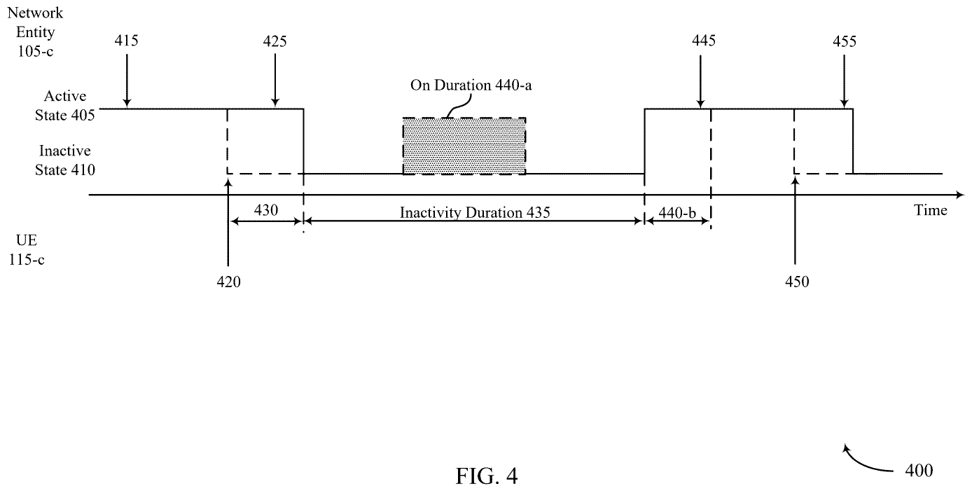

FIG. 4 shows an example of a timing diagram 400 that supports autonomous DRX cycles in wireless communications systems in accordance with one or more aspects of the present disclosure. Aspects of the timing diagram 400 may be implemented by aspects of the wireless communications system 100, the wireless communications system 200, and the process flow 300, as described herein with reference to FIGS. 1 through 3. For example, aspects of the timing diagram 400 may be implemented by a network entity 105-c and a UE 115-c, which may be examples of corresponding devices, as described herein with reference to FIGS. 1 through 3. The timing diagram 400 may illustrate aspects of the process flow 300 with respect to time.

For example, at time 415 and while the UE 115-c is operating in the active state 405, the network entity 105-c may transmit second control signaling (e.g., second control signaling 210, approval indication) indicating that the UE 115-c is permitted to autonomously enter the inactive state 410 (e.g., transmit the approval indication). Accordingly, at time 420, the UE 115-c may transmit third control signaling (e.g., third control signaling 215) including the inactive state indication that indicates the UE 115-c is to enter the inactive state 410. In such examples, the UE 115-c may indicate, via the third control signaling, the inactivity duration 435 (e.g., a duration associated with operating in the inactive state 410).

In some examples, if the UE 115-c is operating according to the second mode of operation (e.g., UE request mode), then, at time 425 and during a hybrid automatic repeat request (HARQ) round trip time (RTT) timer 430, the network entity 105-c may transmit fourth control signaling confirming that the UE 115-c is permitted enter the inactive state 410. In such examples, the network entity 105-c may indicate, via the fourth control signaling, the inactivity duration 435.

Accordingly, after expiration of the HARQ RTT timer 430, in response to receiving the fourth control signaling at 425, or both, the UE 115-c may enter the inactive state 410. In such examples, the UE 115-c may operate in the inactive state 410 for the inactivity duration 435. As such, the UE 115-c may skip one or more DRX on-durations 440-a (e.g., skip operating in the active state 405 for one or more DRX cycles).

In response to expiration of the inactivity duration 435, the UE 115-c may enter the active state 405 at a start of the DRX on-duration 440-b. In such examples, the inactivity duration 435 may extend from an end of a first DRX on-duration and expire at a beginning of the DRX on-duration 440-b. Accordingly, during the on-duration 440-b and at time 445, the UE 115-c may receive second control signaling indicating that the UE 115-c is permitted to enter the inactive state 410. For example, the second control signaling may be a DCI transmitted over a PDCCH, where the DCI may include the NDI. As such, the NDI may be set to a value indicating that the UE 115-c is not receiving any new data, as described herein with reference to FIG. 3. Accordingly, at time 450, the UE 115-c may transmit third control signaling including the inactive state indication indicating that the UE 115-c is to enter the inactive state 410, where the UE 115-c may also indicate a second inactivity duration as described herein with reference to FIGS. 2 and 3.

As such, if the UE 115-c is operating according to the second mode of operation (e.g., UE request mode), then, at time 455 and during a second HARQ RTT timer, the network entity 105-c may transmit fourth control signaling confirming that the UE 115-c is permitted enter the inactive state 410. In such examples, the network entity 105-c may indicate, via the fourth control signaling, the second inactivity duration. Accordingly, after expiration of the second HARQ RTT timer, in response to receiving the fourth control signaling at 455, or both, the UE 115-c may enter the inactive state 410. In such examples, the UE 115-c may operate in the inactive state 410 for the second inactivity duration.

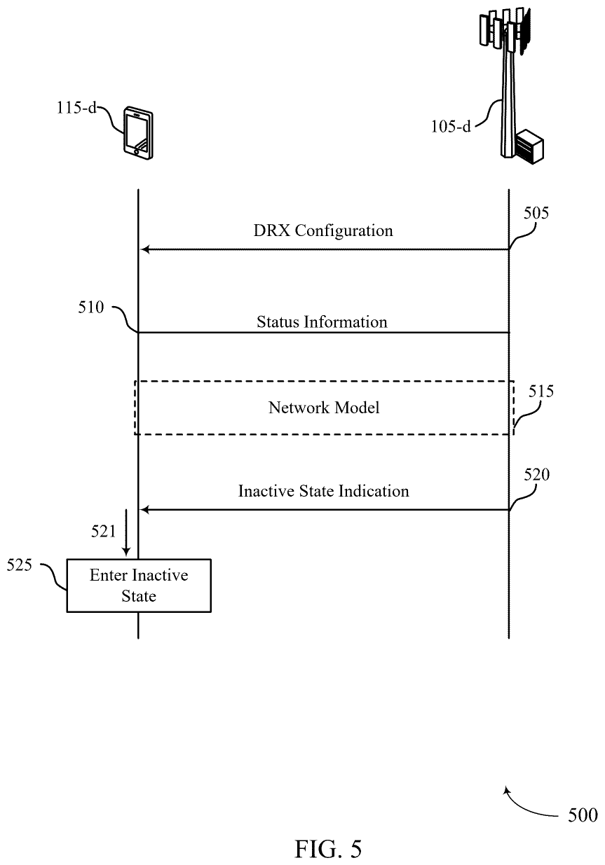

FIG. 5 shows an example of a process flow 500 that supports autonomous DRX cycles in wireless communications systems in accordance with one or more aspects of the present disclosure. Aspects of the process flow 500 may be implemented by aspects of the wireless communications system 100 and the wireless communications system 200, as described herein with reference to FIGS. 1 and 2. For example, aspects of the process flow 500 may be implemented by a network entity 105-d and a UE 115-d, which may be examples of corresponding devices, as described herein with reference to FIGS. 1 and 2. The techniques described in the context of the process flow 500 may enable the network entity 105-d to utilize information received from the UE 115-d in combination with one or more AI or ML models operated by the network entity 105-d to determine whether the UE 115-d enters the inactive state.

For example, at 505, the network entity 105-d may transmit first control signaling to the UE 115-d, where the first control signaling may include a DRX configuration, which may be an example of a DRX configuration as described herein with reference to FIGS. 1 through 4. Accordingly, the UE 115-d may cycle between the active state and the inactive state according to the DRX configuration.

At 510, the UE 115-d may transmit second control signaling (e.g., UCI, RRC signaling, MAC-CE, UE assistance information (UAI)) indicating status information of one or more applications operated by the UE 115-d. That is, at 510, the UE 115-d may provide the status of applications running on the UE 115-d. As described herein with reference to FIG. 3, a modem of the UE 115-d may obtain the status information from the applications operated at the UE 115-d, from the operating system of the application processor at the UE 115-d, or both.

In such examples, the status information may include whether each application is a foreground application (e.g., front running, active and visible on a screen of the UE 115-d, currently active at the UE 115-d) or a background application (e.g., background running, running in a background and not visible on a screen of the UE 115-d, not currently active at the UE 115-d).

In some other examples, the status information may include a buffer status of each application, which may correspond to a quantity of data expected to be transmitted for each application. In some examples, the status information may include an expected next event for each application, for example, whether data is expected to be received or transmitted for each application, an expected off-time for each application, or both. The status information may also include a traffic arrival time for each application, such as an expected time of arrival at the UE 115-d of traffic from the network entity 105-d. Additionally, the status information may include a traffic priority (e.g., urgency) for each application.

At 515, the network entity 105-d may determine whether the UE 115-d is to enter the inactive state, return to the active state, or maintain operating in the active state according to the status information. For example, the network entity 105-d may input the status information into one or more AI or ML models, where, using the AI or ML models, the network entity 105-d may obtain (e.g., calculate, determine, identify) an indication of whether the UE 115-d is to enter the inactive state or not, an indication of a duration the UE 115-d is to operate in the inactive state, an indication of a power state the UE 115-d is to operate in while in the inactive state, an indication of a timing for the UE 115-d to enter the inactive state, or any combination thereof.

At 520, if the network entity 105-d determines that the UE 115-d is to enter the inactive state at 515, the network entity 105-d may transmit third control signaling (e.g., DCI, MAC-CE, UAI, RRC signaling) indicating for the UE 115-d to enter the inactive state. In such examples, the network entity 105-d may also indicate, via the third control signaling, a duration the UE 115-d is to operate in the inactive state, where the duration may be defined in ms, a quantity of slots, a quantity of subframes, a quantity of DRX cycles, or a quantity of DRX on-durations, among other examples. Accordingly, as an illustrative example, the network entity 105-d may indicate for the UE 115-d to operate in the inactive state for 50 ms. Alternatively, the network entity 105-d may indicate for the UE 115-d to operate in the inactive state for 3 slot periods or for 3 DRX on-durations.

Additionally, the network entity 105-d may indicate the timing for the UE 115-d to enter the inactive state (e.g., when the UE 115-d is to enter the inactive state), which may be defined as a duration 521 from reception of the third control signaling at 520. In such examples, the duration may be defined in ms, a quantity of slots, a quantity of subframes, a quantity of DRX cycles, or a quantity of DRX on-durations, among other examples.

As an illustrative example, the network entity 105-d may indicate for the UE 115-d to enter the inactive state 20 ms after reception of the third control signaling. As another illustrative example, the network entity 105-d may indicate for the UE 115-d to enter the inactive state after 2 subsequent slots from reception of the third control signaling.

In some examples, the network entity 105-d may indicate, via the third control signaling, the power state that the UE 115-d is to operate in during the inactive state. For example, the network entity 105-d may indicate for the UE 115-d to operate according to an idle DRX power mode, a connected DRX power mode, a short DRX power mode, or a long DRX power mode. At 525, the UE 115-d may enter the inactive state according to the parameters indicated via the third control signaling at 520.

By indicating for the UE 115-d to enter into the inactive state, the UE 115-d may improve power savings during periods of time with little to no traffic. Additionally, by having the network entity 105-d operate the AI or ML model, the UE 115-d may experience further power savings during active communications by avoiding operating the AI or ML model. Further, by communicating the status information, the network entity 105-d and the UE 115-d may experience improved coordination, in addition to a more accurate output of the AI or ML model from the network entity 105-d, which may improve a reliability of the communications between the UE 115-d and the network entity 105-d.

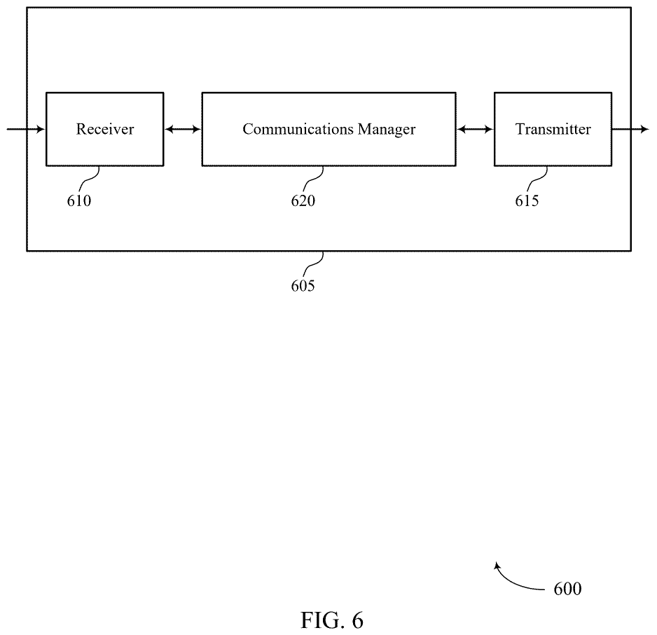

FIG. 6 shows a block diagram 600 of a device 605 that supports autonomous DRX cycles in wireless communications systems in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to autonomous DRX cycles in wireless communications systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to autonomous DRX cycles in wireless communications systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of autonomous DRX cycles in wireless communications systems as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The communications manager 620 is capable of, configured to, or operable to support a means for receiving, during the active state of a first DRX cycle, second control signaling indicating that the UE is permitted to autonomously enter the inactive state for one or more DRX cycles of the set of multiple DRX cycles. The communications manager 620 is capable of, configured to, or operable to support a means for transmitting, in accordance with receiving the second control signaling, third control signaling including an inactive state indication indicating that the UE is to enter the inactive state, where the inactive state indication of the UE is in accordance with an output of an AI model at the UE. The communications manager 620 is capable of, configured to, or operable to support a means for entering the inactive state in accordance with transmitting the third control signaling.

Additionally, or alternatively, the communications manager 620 may support wireless communications in accordance with examples as disclosed herein. For example, the communications manager 620 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The communications manager 620 is capable of, configured to, or operable to support a means for transmitting second control signaling indicating status information of a set of applications operated by the UE. The communications manager 620 is capable of, configured to, or operable to support a means for receiving third control signaling indicating for the UE to enter the inactive state in accordance with the status information of the set of applications operated by the UE. The communications manager 620 is capable of, configured to, or operable to support a means for entering the inactive state in accordance with receiving the third control signaling.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for autonomous DRX cycles at a UE, leading to reduced processing, reduced power consumption, and a more efficient utilization of communication resources.

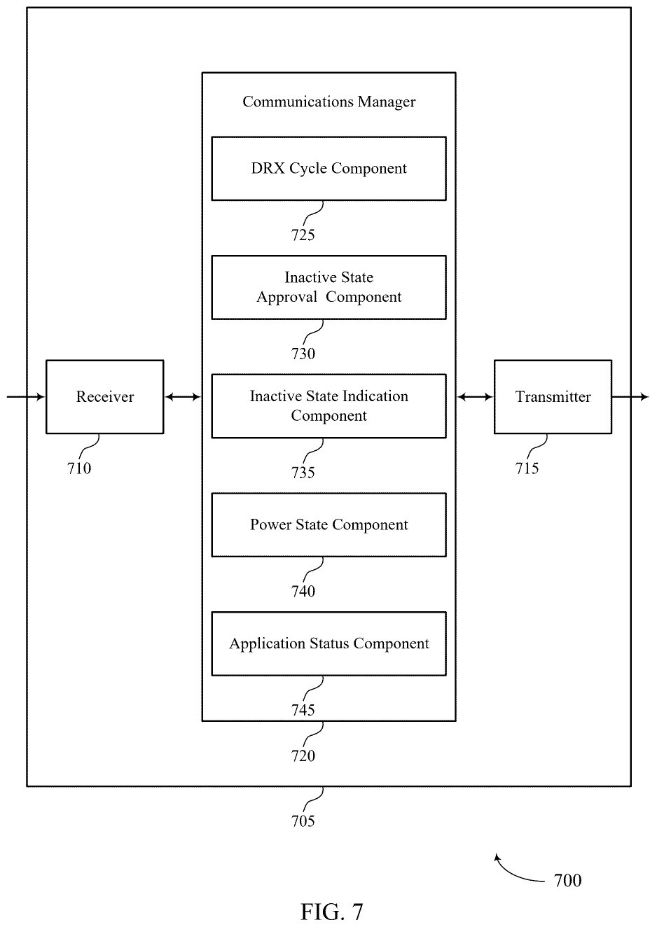

FIG. 7 shows a block diagram 700 of a device 705 that supports autonomous DRX cycles in wireless communications systems in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to autonomous DRX cycles in wireless communications systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to autonomous DRX cycles in wireless communications systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of autonomous DRX cycles in wireless communications systems as described herein. For example, the communications manager 720 may include a DRX cycle component 725, an inactive state approval component 730, an inactive state indication component 735, a power state component 740, an application status component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The DRX cycle component 725 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The inactive state approval component 730 is capable of, configured to, or operable to support a means for receiving, during the active state of a first DRX cycle, second control signaling indicating that the UE is permitted to autonomously enter the inactive state for one or more DRX cycles of the set of multiple DRX cycles. The inactive state indication component 735 is capable of, configured to, or operable to support a means for transmitting, in accordance with receiving the second control signaling, third control signaling including an inactive state indication indicating that the UE is to enter the inactive state, where the inactive state indication of the UE is in accordance with an output of an AI model at the UE. The power state component 740 is capable of, configured to, or operable to support a means for entering the inactive state in accordance with transmitting the third control signaling.

Additionally, or alternatively, the communications manager 720 may support wireless communications in accordance with examples as disclosed herein. The DRX cycle component 725 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The application status component 745 is capable of, configured to, or operable to support a means for transmitting second control signaling indicating status information of a set of applications operated by the UE. The inactive state indication component 735 is capable of, configured to, or operable to support a means for receiving third control signaling indicating for the UE to enter the inactive state in accordance with the status information of the set of applications operated by the UE. The power state component 740 is capable of, configured to, or operable to support a means for entering the inactive state in accordance with receiving the third control signaling.

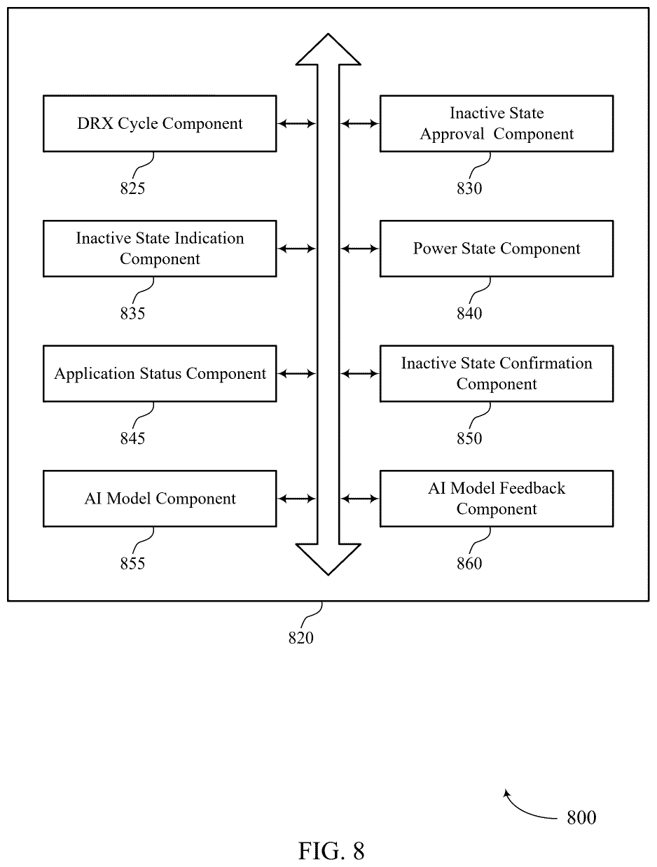

FIG. 8 shows a block diagram 800 of a communications manager 820 that supports autonomous DRX cycles in wireless communications systems in accordance with one or more aspects of the present disclosure. The communications manager 820 may be an example of aspects of a communications manager 620, a communications manager 720, or both, as described herein. The communications manager 820, or various components thereof, may be an example of means for performing various aspects of autonomous DRX cycles in wireless communications systems as described herein. For example, the communications manager 820 may include a DRX cycle component 825, an inactive state approval component 830, an inactive state indication component 835, a power state component 840, an application status component 845, an inactive state confirmation component 850, an AI model component 855, an AI model feedback component 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The DRX cycle component 825 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The inactive state approval component 830 is capable of, configured to, or operable to support a means for receiving, during the active state of a first DRX cycle, second control signaling indicating that the UE is permitted to autonomously enter the inactive state for one or more DRX cycles of the set of multiple DRX cycles. The inactive state indication component 835 is capable of, configured to, or operable to support a means for transmitting, in accordance with receiving the second control signaling, third control signaling including an inactive state indication indicating that the UE is to enter the inactive state, where the inactive state indication of the UE is in accordance with an output of an AI model at the UE. The power state component 840 is capable of, configured to, or operable to support a means for entering the inactive state in accordance with transmitting the third control signaling.

In some examples, the inactive state confirmation component 850 is capable of, configured to, or operable to support a means for receiving, in accordance with transmitting the inactive state indication, fourth control signaling confirming that the UE is permitted to enter the inactive state, where entering the inactive state is in accordance with receiving the fourth control signaling.

In some examples, the inactive state confirmation component 850 is capable of, configured to, or operable to support a means for receiving fifth control signaling indicating for the UE to refrain from entering the inactive state until reception of the fourth control signaling, where receiving the fourth control signaling is in accordance with receiving the fifth control signaling.

In some examples, the fourth control signaling includes an indication of a power state of the UE while in the inactive state, a duration associated with operating in the inactive state, or both.

In some examples, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples, the fourth control signaling indicates a second DRX cycle of the set of multiple DRX cycles in which the UE is to enter the active state from the inactive state.

In some examples, the AI model component 855 is capable of, configured to, or operable to support a means for receiving fourth control signaling including assistance information associated with the AI model at the UE, where the UE uses the assistance information as inputs into the AI model at the UE, and where transmitting the third control signaling is in accordance with the assistance information.

In some examples, the assistance information includes a periodicity metric associated with each communication flow between the UE and a network entity, a jitter metric associated with each communication flow between the UE and the network entity, a priority associated with each communication flow between the UE and the network entity, a PDSB associated with each communication flow between the UE and the network entity, a size of a downlink buffer at the network entity, or any combination thereof.

In some examples, the AI model feedback component 860 is capable of, configured to, or operable to support a means for receiving, in accordance with entering the active state from the inactive state, fourth control signaling including feedback information associated with the AI model at the UE. In some examples, the AI model component 855 is capable of, configured to, or operable to support a means for updating the AI model at the UE in accordance with the feedback information.

In some examples, the feedback information includes a quantity of DCI messages missed by the UE while operating in the inactive state, a bitmap indicating one or more DCI messages of a set of multiple DCI messages that were missed by the UE while operating in the inactive state, or both.

In some examples, the feedback information indicates one or more data radio bearers that were included in one or more transport blocks that were missed by the UE while operating in the inactive state.

In some examples, the feedback information includes a quantity of packets missed by the UE while operating in the inactive state, a priority of each packet missed by the UE while operating in the inactive state, a source IP address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

In some examples, the AI model component 855 is capable of, configured to, or operable to support a means for determining, using the AI model, one or more parameters associated with entering the inactive state in accordance with one or more inputs, where transmitting the third control signaling is in accordance with the one or more parameters determined using the AI model, and where the output of the artificial intelligence model comprises the one or more parameters.

In some examples, the one or more parameters include a time associated with entering the inactive state, a power state of the UE while operating in the inactive state, a duration associated with operating in the inactive state, or any combination thereof.

In some examples, the one or more inputs include a PDB associated with each communication flow between the UE and a network entity, a PDSB associated with each communication flow between the UE and the network entity, a priority associated with each communication flow between the UE and the network entity, a latency associated with each communication flow between the UE and the network entity, a packet data unit set completion percentage associated with each communication flow between the UE and the network entity, or any combination thereof.

In some examples, the one or more inputs include an uplink traffic buffer at the UE, a predicted uplink traffic buffer at the UE, one or more operational parameters associated with one or more applications operated by the UE, one or more power parameters at the UE, one or more sleep cycles at the UE, or any combination thereof.

In some examples, the first control signaling includes one or more key performance indicators associated with an accuracy of the AI model at the UE, and the AI model component 855 is capable of, configured to, or operable to support a means for updating the AI model to satisfy the one or more key performance indicators.

In some examples, the one or more key performance indicators include a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

In some examples, to support entering the inactive state, the power state component 840 is capable of, configured to, or operable to support a means for entering the inactive state after a duration from transmission of the third control signaling, where the duration is indicated via the first control signaling, the second control signaling, or a fourth control signaling.

In some examples, the second control signaling further indicates a set of multiple durations associated with operating in the inactive state, and the power state component 840 is capable of, configured to, or operable to support a means for operating within the inactive state for one of the set of multiple durations.

In some examples, each duration of the set of multiple durations includes a respective quantity of DRX cycles associated with operating in the inactive state, a respective quantity of subframes associated with operating in the inactive state, a respective quantity of slots associated with operating in the inactive state, or any combination thereof.

In some examples, the second control signaling further indicates a timer associated with transmission of the third control signaling, and the inactive state indication component 835 is capable of, configured to, or operable to support a means for transmitting the third control signaling in accordance with expiration of the timer, where the timer begins in accordance with reception of the second control signaling at the UE.

In some examples, the second control signaling includes a downlink data indicator. In some examples, a first value of the downlink data indicator indicates that the UE is to receive one or more downlink signals. In some examples, a second value of the downlink data indicator indicates that the UE is permitted to autonomously enter the inactive state for the one or more DRX cycles.

In some examples, the third control signaling includes an indication of a power state of the UE while operating in the inactive state, a duration associated with operating in the inactive state, or both.

In some examples, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples, the power state of the UE includes an idle DRX power mode, a connected DRX power mode, a short DRX power mode, or a long DRX power mode.

Additionally, or alternatively, the communications manager 820 may support wireless communications in accordance with examples as disclosed herein. In some examples, the DRX cycle component 825 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The application status component 845 is capable of, configured to, or operable to support a means for transmitting second control signaling indicating status information of a set of applications operated by the UE. In some examples, the inactive state indication component 835 is capable of, configured to, or operable to support a means for receiving third control signaling indicating for the UE to enter the inactive state in accordance with the status information of the set of applications operated by the UE. In some examples, the power state component 840 is capable of, configured to, or operable to support a means for entering the inactive state in accordance with receiving the third control signaling.

In some examples, the status information includes an indication that a first subset of the set of applications are associated with a first operational status and a second subset of the set of applications are associated with a second operational status, the first operational status associated with increased power consumption at the UE relative to the second operational status, and indicating for the UE to enter the inactive state is based on the indication of the first subset of the set of applications and the second subset of the set of applications.

In some examples, the status information includes an indication of a respective buffer status of each of the set of applications, and indicating for the UE to enter the inactive state is based on the indication of the respective buffer status of each of the set of applications.

In some examples, the status information includes an indication of a respective traffic time arrival associated with each of the set of applications, and indicating for the UE to enter the inactive state is based on the indication of the respective traffic time arrival of each of the set of applications.

In some examples, the status information includes an indication of a respective expected event associated with each of the set of applications, and indicating for the UE to enter the inactive state is based on the indication of the respective expected event of each of the set of applications.

In some examples, the status information includes an indication of a respective traffic priority associated with each of the set of applications, and indicating for the UE to enter the inactive state is based on the indication of the respective traffic priority of each of the set of applications.

In some examples, the third control signaling further indicates a duration associated with operating in the inactive state. In some examples, the duration includes a quantity of DRX cycles associated with operating in the inactive state, a quantity of subframes associated with operating in the inactive state, a quantity of slots associated with operating in the inactive state, or any combination thereof.

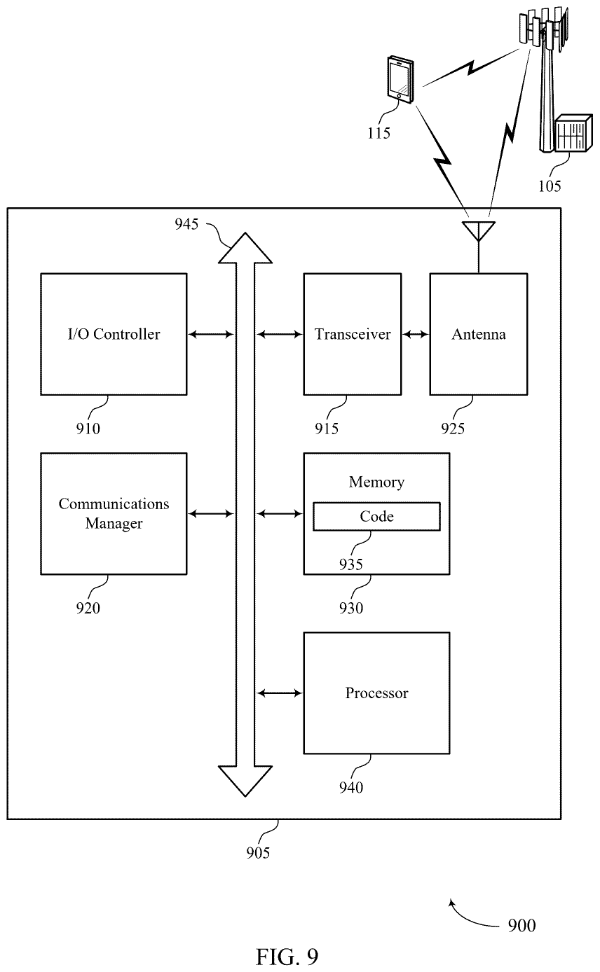

FIG. 9 shows a diagram of a system 900 including a device 905 that supports autonomous DRX cycles in wireless communications systems in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting autonomous DRX cycles in wireless communications systems). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The communications manager 920 is capable of, configured to, or operable to support a means for receiving, during the active state of a first DRX cycle, second control signaling indicating that the UE is permitted to autonomously enter the inactive state for one or more DRX cycles of the set of multiple DRX cycles. The communications manager 920 is capable of, configured to, or operable to support a means for transmitting, in accordance with receiving the second control signaling, third control signaling including an inactive state indication indicating that the UE is to enter the inactive state, where the inactive state indication of the UE is in accordance with an output of an AI model at the UE. The communications manager 920 is capable of, configured to, or operable to support a means for entering the inactive state in accordance with transmitting the third control signaling.

Additionally, or alternatively, the communications manager 920 may support wireless communications in accordance with examples as disclosed herein. For example, the communications manager 920 is capable of, configured to, or operable to support a means for receiving first control signaling indicating a set of multiple DRX cycles, where each DRX cycle of the set of multiple DRX cycles includes a respective first duration associated with an active state at the UE, a respective second duration associated with an inactive state at the UE, or both. The communications manager 920 is capable of, configured to, or operable to support a means for transmitting second control signaling indicating status information of a set of applications operated by the UE. The communications manager 920 is capable of, configured to, or operable to support a means for receiving third control signaling indicating for the UE to enter the inactive state in accordance with the status information of the set of applications operated by the UE. The communications manager 920 is capable of, configured to, or operable to support a means for entering the inactive state in accordance with receiving the third control signaling.

By including or configuring the communications manager 920 in accordance with examples as described herein, the device 905 may support techniques for autonomous DRX cycles at a UE, leading to improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of autonomous DRX cycles in wireless communications systems as described herein, or the at least one processor 940 and the at least one memory 930 may be otherwise configured to, individually or collectively, perform or support such operations.

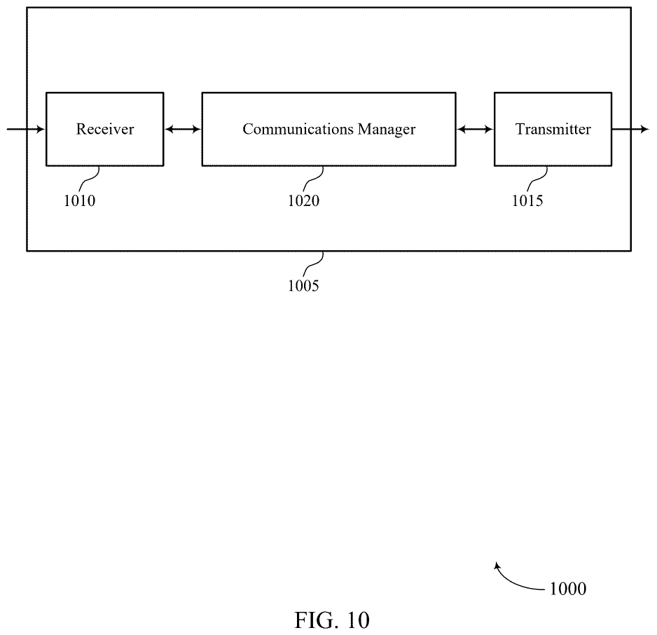

FIG. 10 shows a block diagram 1000 of a device 1005 that supports autonomous DRX cycles in wireless communications systems in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of autonomous DRX cycles in wireless communications systems as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The communications manager 1020 is capable of, configured to, or operable to support a means for obtaining second control signaling indicating status information of a set of applications operated by the UE. The communications manager 1020 is capable of, configured to, or operable to support a means for outputting third control signaling indicating for the UE to enter the inactive state in accordance with an AI model operated at the network entity, where the status information is an input to the AI model.

Additionally, or alternatively, the communications manager 1020 may support wireless communications in accordance with examples as disclosed herein. For example, the communications manager 1020 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The communications manager 1020 is capable of, configured to, or operable to support a means for outputting, during the active state of a first DRX cycle, second control signaling indicating that the UE is permitted to autonomously enter the inactive state for one or more DRX cycles of the set of multiple DRX cycles. The communications manager 1020 is capable of, configured to, or operable to support a means for obtaining, in accordance with outputting the second control signaling, third control signaling including an inactive state indication indicating that the UE is to enter the inactive state.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for autonomous DRX cycles, leading to reduced processing, reduced power consumption, and more efficient utilization of communication resources.

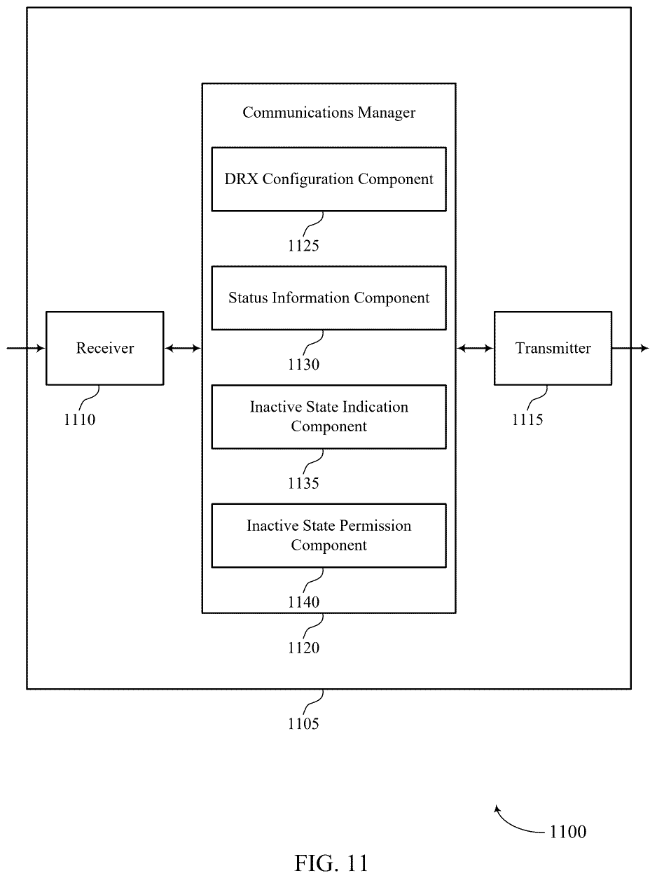

FIG. 11 shows a block diagram 1100 of a device 1105 that supports autonomous DRX cycles in wireless communications systems in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of autonomous DRX cycles in wireless communications systems as described herein. For example, the communications manager 1120 may include a DRX configuration component 1125, a status information component 1130, an inactive state indication component 1135, an inactive state permission component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The DRX configuration component 1125 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The status information component 1130 is capable of, configured to, or operable to support a means for obtaining second control signaling indicating status information of a set of applications operated by the UE. The inactive state indication component 1135 is capable of, configured to, or operable to support a means for outputting third control signaling indicating for the UE to enter the inactive state in accordance with an AI model operated at the network entity, where the status information is an input to the AI model.

Additionally, or alternatively, the communications manager 1120 may support wireless communications in accordance with examples as disclosed herein. The DRX configuration component 1125 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The inactive state permission component 1140 is capable of, configured to, or operable to support a means for outputting, during the active state of a first DRX cycle, second control signaling indicating that the UE is permitted to autonomously enter the inactive state for one or more DRX cycles of the set of multiple DRX cycles. The inactive state indication component 1135 is capable of, configured to, or operable to support a means for obtaining, in accordance with outputting the second control signaling, third control signaling including an inactive state indication indicating that the UE is to enter the inactive state.

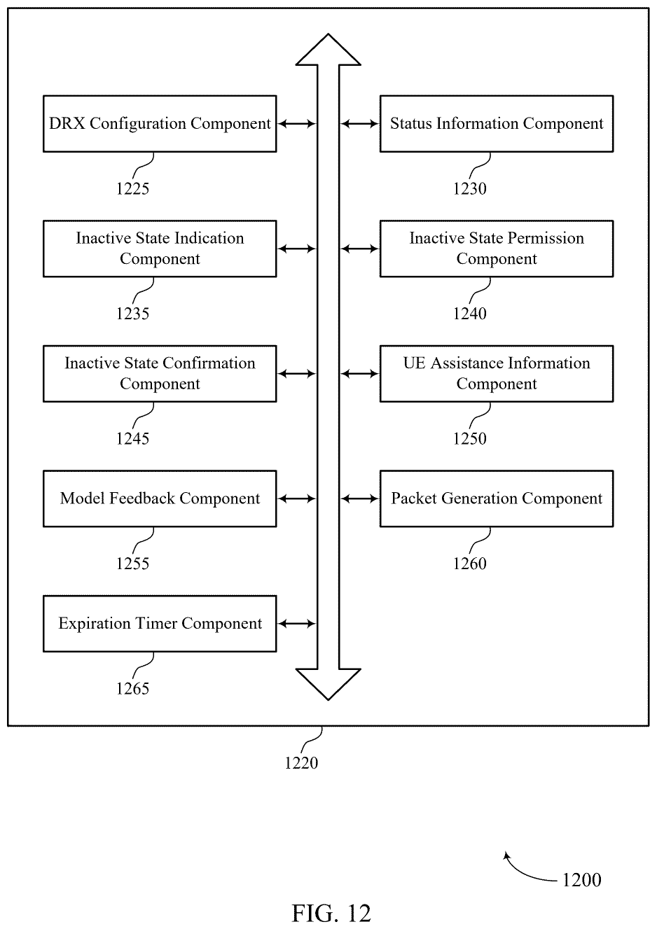

FIG. 12 shows a block diagram 1200 of a communications manager 1220 that supports autonomous DRX cycles in wireless communications systems in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of autonomous DRX cycles in wireless communications systems as described herein. For example, the communications manager 1220 may include a DRX configuration component 1225, a status information component 1230, an inactive state indication component 1235, an inactive state permission component 1240, an inactive state confirmation component 1245, a UE assistance information component 1250, a model feedback component 1255, a packet generation component 1260, an expiration timer component 1265, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The DRX configuration component 1225 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The status information component 1230 is capable of, configured to, or operable to support a means for obtaining second control signaling indicating status information of a set of applications operated by the UE. The inactive state indication component 1235 is capable of, configured to, or operable to support a means for outputting third control signaling indicating for the UE to enter the inactive state in accordance with an AI model operated at the network entity, where the status information is an input to the AI model.

In some examples, the status information includes an indication that a first subset of the set of applications are associated with a first operational status and a second subset of the set of applications are associated with a second operational status, the first operational status associated with increased power consumption at the UE relative to the second operational status, and indicating for the UE to enter the inactive state is based on the indication of the first subset of the set of applications and the second subset of the set of applications.

In some examples, the status information includes an indication of a respective buffer status of each of the set of applications, and indicating for the UE to enter the inactive state is based on the indication of the respective buffer status of each of the set of applications.

In some examples, the status information includes an indication of a respective traffic time arrival associated with each of the set of applications, and indicating for the UE to enter the inactive state is based on the indication of the respective traffic time arrival of each of the set of applications.

In some examples, the status information includes an indication of a respective expected event associated with each of the set of applications, and indicating for the UE to enter the inactive state is based on the indication of the respective expected event of each of the set of applications.

In some examples, the status information includes an indication of a respective traffic priority associated with each of the set of applications, and indicating for the UE to enter the inactive state is based on the indication of the respective traffic priority of each of the set of applications.

In some examples, the third control signaling further indicates a duration associated with operating in the inactive state. In some examples, the duration includes a quantity of DRX cycles associated with operating in the inactive state, a quantity of subframes associated with operating in the inactive state, a quantity of slots associated with operating in the inactive state, or any combination thereof.

Additionally, or alternatively, the communications manager 1220 may support wireless communications in accordance with examples as disclosed herein. In some examples, the DRX configuration component 1225 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The inactive state permission component 1240 is capable of, configured to, or operable to support a means for outputting, during the active state of a first DRX cycle, second control signaling indicating that the UE is permitted to autonomously enter the inactive state for one or more DRX cycles of the set of multiple DRX cycles. In some examples, the inactive state indication component 1235 is capable of, configured to, or operable to support a means for obtaining, in accordance with outputting the second control signaling, third control signaling including an inactive state indication indicating that the UE is to enter the inactive state.

In some examples, the inactive state confirmation component 1245 is capable of, configured to, or operable to support a means for outputting, in accordance with obtaining the inactive state indication, fourth control signaling confirming that the UE is permitted to enter the inactive state.

In some examples, the inactive state indication component 1235 is capable of, configured to, or operable to support a means for outputting fifth control signaling indicating for the UE to refrain from entering the inactive state until output of the fourth control signaling, where outputting the fourth control signaling is in accordance with outputting the fifth control signaling.

In some examples, the fourth control signaling includes an indication of a power state of the UE while in the inactive state, a duration associated with operating in the inactive state, or both.

In some examples, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples, the fourth control signaling indicates a second DRX cycle of the set of multiple DRX cycles in which the UE is to enter the active state from the inactive state.

In some examples, the UE assistance information component 1250 is capable of, configured to, or operable to support a means for outputting fourth control signaling including assistance information associated with an AI model at the UE, where obtaining the third control signaling is in accordance with outputting the assistance information.

In some examples, the assistance information includes a periodicity metric associated with each communication flow between the UE and the network entity, a jitter metric associated with each communication flow between the UE and the network entity, a priority associated with each communication flow between the UE and the network entity, a PDSB associated with each communication flow between the UE and the network entity, a size of a downlink buffer at the network entity, or any combination thereof.

In some examples, the model feedback component 1255 is capable of, configured to, or operable to support a means for outputting, in accordance with obtaining the third control signaling, fourth control signaling including feedback information associated with an AI model at the UE.

In some examples, the feedback information includes a quantity of DCI messages missed by the UE while operating in the inactive state, a bitmap indicating one or more DCI messages of a set of multiple DCI messages that were missed by the UE while operating in the inactive state, or both.

In some examples, the feedback information indicates one or more data radio bearers that were included in one or more transport blocks that were missed by the UE while operating in the inactive state.

In some examples, the feedback information includes a quantity of packets missed by the UE while operating in the inactive state, a priority of each packet missed by the UE while operating in the inactive state, a source IP address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

In some examples, the first control signaling includes one or more key performance indicators associated with an accuracy of an AI model at the UE.

In some examples, the one or more key performance indicators include a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

In some examples, the inactive state indication component 1235 is capable of, configured to, or operable to support a means for outputting an indication of a duration from obtaining the third control signaling, where the UE is permitted to enter the inactive state after the duration. In some examples, the packet generation component 1260 is capable of, configured to, or operable to support a means for communicating one or more message with the UE during the duration.

In some examples, the second control signaling further indicates a set of multiple durations associated with operating in the inactive state.

In some examples, each duration of the set of multiple durations includes a respective quantity of DRX cycles associated with operating in the inactive state, a respective quantity of subframes associated with operating in the inactive state, a respective quantity of slots associated with operating in the inactive state, or any combination thereof.

In some examples, the second control signaling further indicates a timer associated with obtaining the third control signaling, and the expiration timer component 1265 is capable of, configured to, or operable to support a means for obtaining the third control signaling in accordance with expiration of the timer, where the timer begins in accordance with output of the second control signaling.

In some examples, the second control signaling includes a downlink data indicator. In some examples, a first value of the downlink data indicator indicates that the network entity is to transmit one or more downlink signals. In some examples, a second value of the downlink data indicator indicates that the UE is permitted to autonomously enter the inactive state for the one or more DRX cycles.

In some examples, the third control signaling includes an indication of a power state of the UE while operating in the inactive state, a duration associated with operating in the inactive state, or both.

In some examples, the duration associated with operating in the inactive state includes a quantity of DRX cycles associated with operating in the inactive state, a quantity of subframes associated with operating in the inactive state, a quantity of slots associated with operating in the inactive state, or any combination thereof.

In some examples, the power state of the UE includes an idle DRX power mode, a connected DRX power mode, a short DRX power mode, or a long DRX power mode.

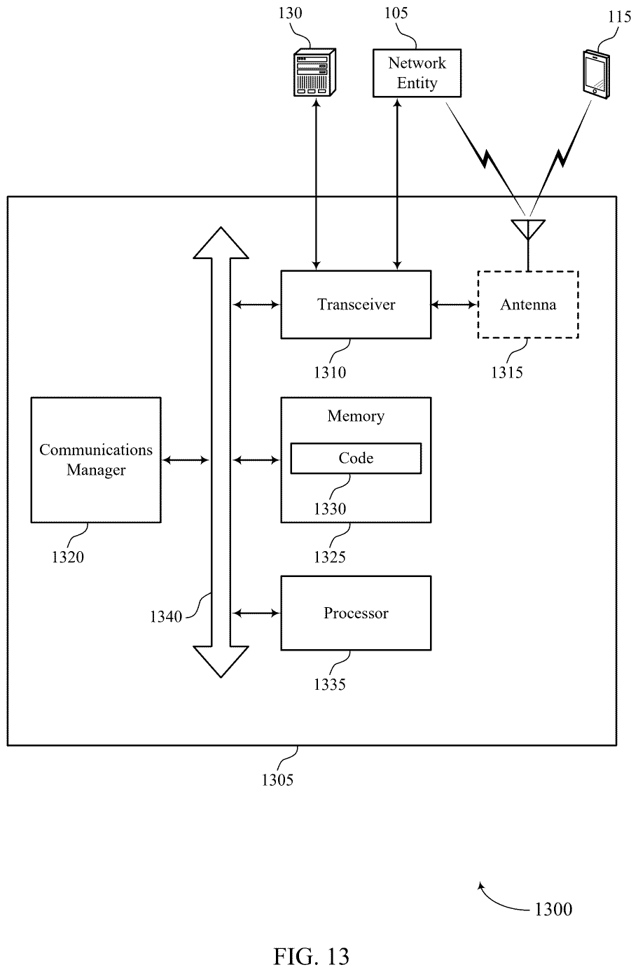

FIG. 13 shows a diagram of a system 1300 including a device 1305 that supports autonomous DRX cycles in wireless communications systems in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting autonomous DRX cycles in wireless communications systems). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The communications manager 1320 is capable of, configured to, or operable to support a means for obtaining second control signaling indicating status information of a set of applications operated by the UE. The communications manager 1320 is capable of, configured to, or operable to support a means for outputting third control signaling indicating for the UE to enter the inactive state in accordance with an AI model operated at the network entity, where the status information is an input to the AI model.

Additionally, or alternatively, the communications manager 1320 may support wireless communications in accordance with examples as disclosed herein. For example, the communications manager 1320 is capable of, configured to, or operable to support a means for outputting first control signaling indicating a set of multiple DRX cycles, where each DRX cycle of the set of multiple DRX cycles includes a respective first duration associated with an active state at a UE, a respective second duration associated with an inactive state at the UE, or both. The communications manager 1320 is capable of, configured to, or operable to support a means for outputting, during the active state of a first DRX cycle, second control signaling indicating that the UE is permitted to autonomously enter the inactive state for one or more DRX cycles of the set of multiple DRX cycles. The communications manager 1320 is capable of, configured to, or operable to support a means for obtaining, in accordance with outputting the second control signaling, third control signaling including an inactive state indication indicating that the UE is to enter the inactive state.

By including or configuring the communications manager 1320 in accordance with examples as described herein, the device 1305 may support techniques for autonomous DRX cycles, leading to improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of autonomous DRX cycles in wireless communications systems as described herein, or the at least one processor 1335 and the at least one memory 1325 may be otherwise configured to, individually or collectively, perform or support such operations.

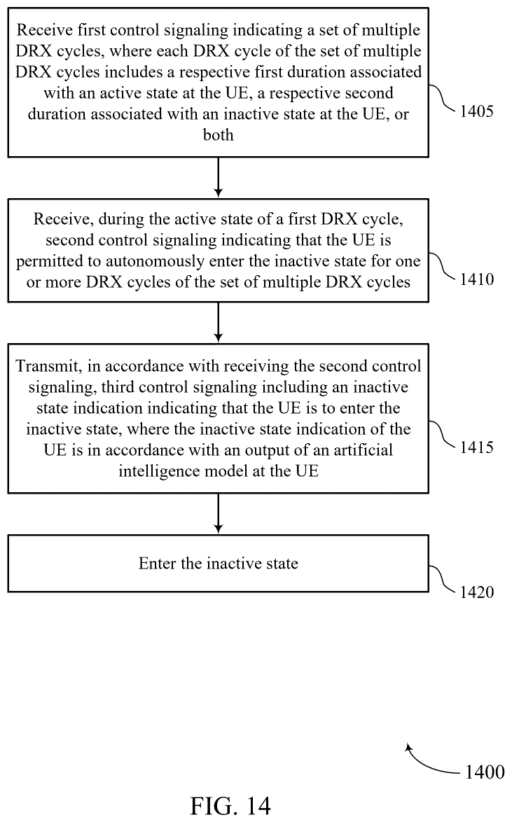

FIG. 14 shows a flowchart illustrating a method 1400 that supports autonomous DRX cycles in wireless communications systems in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control signaling indicating a set of multiple DRX cycles, where each DRX cycle of the set of multiple DRX cycles includes a respective first duration associated with an active state at the UE, a respective second duration associated with an inactive state at the UE, or both. The operations of 1405 may be performed in accordance with examples as disclosed herein. In some examples, aspects of the operations of 1405 may be performed by a DRX cycle component 825 as described with reference to FIG. 8.

At 1410, the method may include receiving, during the active state of a first DRX cycle, second control signaling indicating that the UE is permitted to autonomously enter the inactive state for one or more DRX cycles of the set of multiple DRX cycles. The operations of 1410 may be performed in accordance with examples as disclosed herein. In some examples, aspects of the operations of 1410 may be performed by an inactive state approval component 830 as described with reference to FIG. 8.

At 1415, the method may include transmitting, in accordance with receiving the second control signaling, third control signaling including an inactive state indication indicating that the UE is to enter the inactive state, where the inactive state indication of the UE is in accordance with an output of an AI model at the UE. The operations of 1415 may be performed in accordance with examples as disclosed herein. In some examples, aspects of the operations of 1415 may be performed by an inactive state indication component 835 as described with reference to FIG. 8.

At 1420, the method may include entering the inactive state. The operations of 1420 may be performed in accordance with examples as disclosed herein. In some examples, aspects of the operations of 1420 may be performed by a power state component 840 as described with reference to FIG. 8.

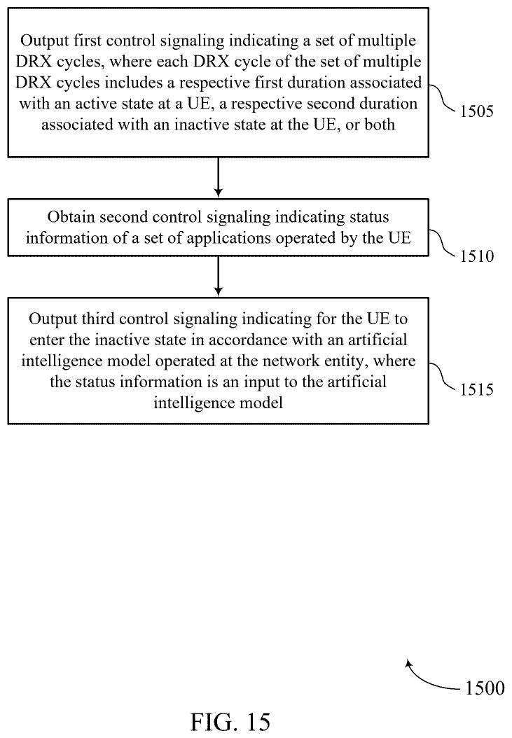

FIG. 15 shows a flowchart illustrating a method 1500 that supports autonomous DRX cycles in wireless communications systems in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting first control signaling indicating a set of multiple DRX cycles, where each DRX cycle of the set of multiple DRX cycles includes a respective first duration associated with an active state at a UE, a respective second duration associated with an inactive state at the UE, or both. The operations of 1505 may be performed in accordance with examples as disclosed herein. In some examples, aspects of the operations of 1505 may be performed by a DRX configuration component 1225 as described with reference to FIG. 12.

At 1510, the method may include obtaining second control signaling indicating status information of a set of applications operated by the UE. The operations of 1510 may be performed in accordance with examples as disclosed herein. In some examples, aspects of the operations of 1510 may be performed by a status information component 1230 as described with reference to FIG. 12.

At 1515, the method may include outputting third control signaling indicating for the UE to enter the inactive state in accordance with an AI model operated at the network entity, where the status information is an input to the AI model. The operations of 1515 may be performed in accordance with examples as disclosed herein. In some examples, aspects of the operations of 1515 may be performed by an inactive state indication component 1235 as described with reference to FIG. 12.

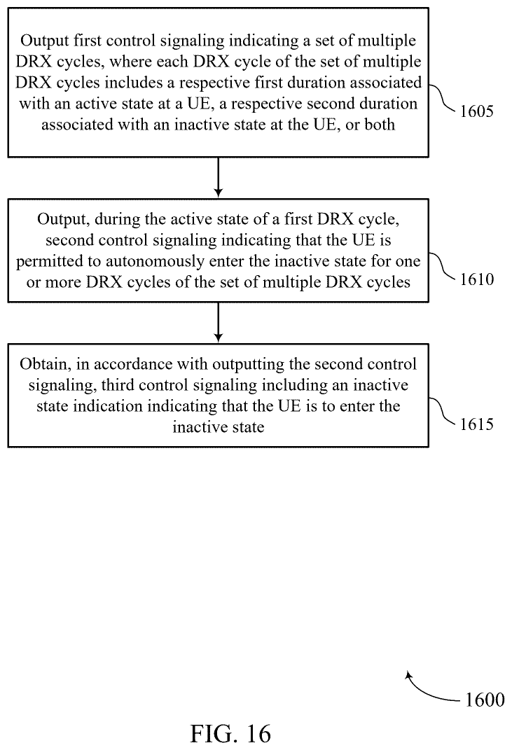

FIG. 16 shows a flowchart illustrating a method 1600 that supports autonomous DRX cycles in wireless communications systems in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting first control signaling indicating a set of multiple DRX cycles, where each DRX cycle of the set of multiple DRX cycles includes a respective first duration associated with an active state at a UE, a respective second duration associated with an inactive state at the UE, or both. The operations of 1605 may be performed in accordance with examples as disclosed herein. In some examples, aspects of the operations of 1605 may be performed by a DRX configuration component 1225 as described with reference to FIG. 12.

At 1610, the method may include outputting, during the active state of a first DRX cycle, second control signaling indicating that the UE is permitted to autonomously enter the inactive state for one or more DRX cycles of the set of multiple DRX cycles. The operations of 1610 may be performed in accordance with examples as disclosed herein. In some examples, aspects of the operations of 1610 may be performed by an inactive state permission component 1240 as described with reference to FIG. 12.

At 1615, the method may include obtaining, in accordance with outputting the second control signaling, third control signaling including an inactive state indication indicating that the UE is to enter the inactive state. The operations of 1615 may be performed in accordance with examples as disclosed herein. In some examples, aspects of the operations of 1615 may be performed by an inactive state indication component 1235 as described with reference to FIG. 12.

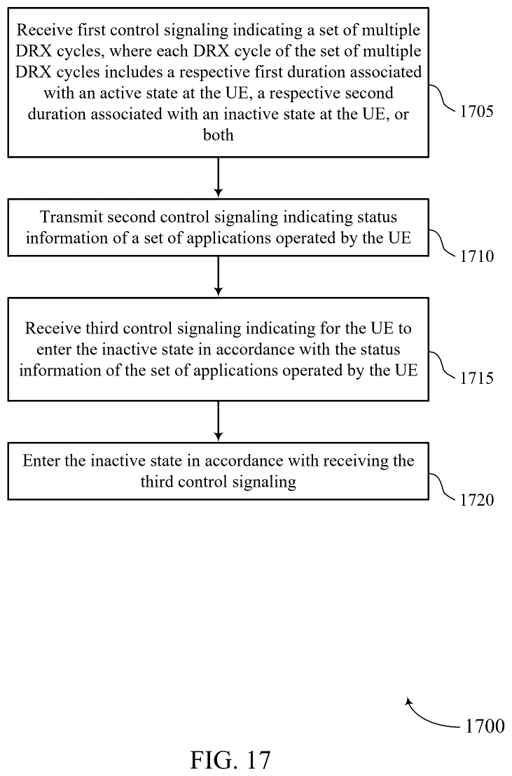

FIG. 17 shows a flowchart illustrating a method 1700 that supports autonomous DRX cycles in wireless communications systems in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving first control signaling indicating a set of multiple DRX cycles, where each DRX cycle of the set of multiple DRX cycles includes a respective first duration associated with an active state at the UE, a respective second duration associated with an inactive state at the UE, or both. The operations of 1705 may be performed in accordance with examples as disclosed herein. In some examples, aspects of the operations of 1705 may be performed by a DRX cycle component 825 as described with reference to FIG. 8.

At 1710, the method may include transmitting second control signaling indicating status information of a set of applications operated by the UE. The operations of 1710 may be performed in accordance with examples as disclosed herein. In some examples, aspects of the operations of 1710 may be performed by an application status component 845 as described with reference to FIG. 8.

At 1715, the method may include receiving third control signaling indicating for the UE to enter the inactive state in accordance with the status information of the set of applications operated by the UE. The operations of 1715 may be performed in accordance with examples as disclosed herein. In some examples, aspects of the operations of 1715 may be performed by an inactive state indication component 835 as described with reference to FIG. 8.

At 1720, the method may include entering the inactive state in accordance with receiving the third control signaling. The operations of 1720 may be performed in accordance with examples as disclosed herein. In some examples, aspects of the operations of 1720 may be performed by a power state component 840 as described with reference to FIG. 8.

The following provides an overview of aspects of the present disclosure:

Aspect 1: A method for wireless communications at a UE, comprising: receiving first control signaling indicating a plurality of DRX cycles, wherein each DRX cycle of the plurality of DRX cycles comprises a respective first duration associated with an active state at the UE, a respective second duration associated with an inactive state at the UE, or both; receiving, during the active state of a first DRX cycle, second control signaling indicating that the UE is permitted to autonomously enter the inactive state for one or more DRX cycles of the plurality of DRX cycles; transmitting, in accordance with receiving the second control signaling, third control signaling comprising an inactive state indication indicating that the UE is to enter the inactive state, wherein the inactive state indication of the UE is in accordance with an output of an artificial intelligence model at the UE; and entering the inactive state.

Aspect 2: The method of aspect 1, further comprising: receiving, in accordance with transmitting the inactive state indication, fourth control signaling confirming that the UE is permitted to enter the inactive state, wherein entering the inactive state is in accordance with receiving the fourth control signaling.

Aspect 3: The method of aspect 2, further comprising: receiving fifth control signaling indicating for the UE to refrain from entering the inactive state until reception of the fourth control signaling, wherein receiving the fourth control signaling is in accordance with receiving the fifth control signaling.

Aspect 4: The method of any of aspects 2 through 3, wherein the fourth control signaling comprises an indication of a power state of the UE while in the inactive state, a duration associated with operating in the inactive state, or both.

Aspect 5: The method of aspect 4, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

Aspect 6: The method of any of aspects 2 through 5, wherein the fourth control signaling indicates a second DRX cycle of the plurality of DRX cycles in which the UE is to enter the active state from the inactive state.

Aspect 7: The method of aspect 1, further comprising: receiving fourth control signaling comprising assistance information associated with the artificial intelligence model at the UE, wherein the UE uses the assistance information as inputs into the artificial intelligence model at the UE, and wherein transmitting the third control signaling is in accordance with the assistance information.

Aspect 8: The method of aspect 7, wherein the assistance information comprises a periodicity metric associated with each communication flow between the UE and a network entity, a jitter metric associated with each communication flow between the UE and the network entity, a priority associated with each communication flow between the UE and the network entity, a PDSB associated with each communication flow between the UE and the network entity, a size of a downlink buffer at the network entity, or any combination thereof.

Aspect 9: The method of aspect 1, further comprising: receiving, in accordance with entering the active state from the inactive state, fourth control signaling comprising feedback information associated with the artificial intelligence model at the UE; and updating the artificial intelligence model at the UE in accordance with the feedback information.

Aspect 10: The method of aspect 9, wherein the feedback information comprises a quantity of DCI messages missed by the UE while operating in the inactive state, a bitmap indicating one or more DCI messages of a plurality of DCI messages that were missed by the UE while operating in the inactive state, or both.

Aspect 11: The method of any of aspects 9 through 10, wherein the feedback information indicates one or more data radio bearers that were included in one or more transport blocks that were missed by the UE while operating in the inactive state.

Aspect 12: The method of any of aspects 9 through 11, wherein the feedback information comprises a quantity of packets missed by the UE while operating in the inactive state, a priority of each packet missed by the UE while operating in the inactive state, a source IP address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

Aspect 13: The method of any of aspects 1 through 12, further comprising: determining, using the artificial intelligence model, one or more parameters associated with entering the inactive state in accordance with one or more inputs, wherein transmitting the third control signaling is in accordance with the one or more parameters determined using the artificial intelligence model, and where the output of the artificial intelligence model comprises the one or more parameters.

Aspect 14: The method of aspect 13, wherein the one or more parameters comprise a time associated with entering the inactive state, a power state of the UE while operating in the inactive state, a duration associated with operating in the inactive state, or any combination thereof.

Aspect 15: The method of any of aspects 13 through 14, wherein the one or more inputs comprise a PDB associated with each communication flow between the UE and a network entity, a PDSB associated with each communication flow between the UE and the network entity, a priority associated with each communication flow between the UE and the network entity, a latency associated with each communication flow between the UE and the network entity, a packet data unit set completion percentage associated with each communication flow between the UE and the network entity, or any combination thereof.

Aspect 16: The method of any of aspects 13 through 15, wherein the one or more inputs comprise an uplink traffic buffer at the UE, a predicted uplink traffic buffer at the UE, one or more operational parameters associated with one or more applications operated by the UE, one or more power parameters at the UE, one or more sleep cycles at the UE, or any combination thereof.

Aspect 17: The method of any of aspects 1 through 16, wherein the first control signaling comprises one or more key performance indicators associated with an accuracy of the artificial intelligence model at the UE, the method further comprising: updating the artificial intelligence model to satisfy the one or more key performance indicators.

Aspect 18: The method of aspect 17, wherein the one or more key performance indicators comprise a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

Aspect 19: The method of any of aspects 1 through 18, wherein entering the inactive state comprises: entering the inactive state after a duration from transmission of the third control signaling, wherein the duration is indicated via the first control signaling, the second control signaling, or a fourth control signaling.

Aspect 20: The method of any of aspects 1 through 19, wherein the second control signaling further indicates a plurality of durations associated with operating in the inactive state, the method further comprising: operating within the inactive state for one of the plurality of durations.

Aspect 21: The method of aspect 20, wherein each duration of the plurality of durations comprises a respective quantity of DRX cycles associated with operating in the inactive state, a respective quantity of subframes associated with operating in the inactive state, a respective quantity of slots associated with operating in the inactive state, or any combination thereof.

Aspect 22: The method of any of aspects 1 through 21, wherein the second control signaling further indicates a timer associated with transmission of the third control signaling, the method further comprising: transmitting the third control signaling in accordance with expiration of the timer, wherein the timer begins in accordance with reception of the second control signaling at the UE.

Aspect 23: The method of any of aspects 1 through 22, wherein the second control signaling comprises a downlink data indicator, a first value of the downlink data indicator indicates that the UE is to receive one or more downlink signals, and a second value of the downlink data indicator indicates that the UE is permitted to autonomously enter the inactive state for the one or more DRX cycles.

Aspect 24: The method of any of aspects 1 through 23, wherein the third control signaling comprises an indication of a power state of the UE while operating in the inactive state, a duration associated with operating in the inactive state, or both.

Aspect 25: The method of aspect 24, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

Aspect 26: The method of any of aspects 24 through 25, wherein the power state of the UE comprises an idle DRX power mode, a connected DRX power mode, a short DRX power mode, or a long DRX power mode.

Aspect 27: The method of any of aspects 2 through 26, wherein the UE enters the inactive state in accordance with transmitting the third control signaling.

Aspect 28: A method for wireless communications at a network entity, comprising: outputting first control signaling indicating a plurality of DRX cycles, wherein each DRX cycle of the plurality of DRX cycles comprises a respective first duration associated with an active state at a UE, a respective second duration associated with an inactive state at the UE, or both; obtaining second control signaling indicating status information of a set of applications operated by the UE; and outputting third control signaling indicating for the UE to enter the inactive state in accordance with an artificial intelligence model operated at the network entity, wherein the status information is an input to the artificial intelligence model.

Aspect 29: The method of aspect 28, wherein the status information comprises an indication that a first subset of the set of applications are associated with a first operational status and a second subset of the set of applications are associated with a second operational status, the first operational status associated with increased power consumption at the UE relative to the second operational status, and indicating for the UE to enter the inactive state is based at least in part on the indication of the first subset of the set of applications and the second subset of the set of applications.

Aspect 30: The method of any of aspects 28 through 29, wherein the status information comprises an indication of a respective buffer status of each of the set of applications, and indicating for the UE to enter the inactive state is based at least in part on the indication of the respective buffer status of each of the set of applications.

Aspect 31: The method of any of aspects 28 through 30, wherein the status information comprises an indication of a respective traffic time arrival associated with each of the set of applications, and indicating for the UE to enter the inactive state is based at least in part on the indication of the respective traffic time arrival of each of the set of applications.

Aspect 32: The method of any of aspects 28 through 31, wherein the status information comprises an indication of a respective expected event associated with each of the set of applications, and indicating for the UE to enter the inactive state is based at least in part on the indication of the respective expected event of each of the set of applications.

Aspect 33: The method of any of aspects 28 through 32, wherein the status information comprises an indication of a respective traffic priority associated with each of the set of applications, and indicating for the UE to enter the inactive state is based at least in part on the indication of the respective traffic priority of each of the set of applications.

Aspect 34: The method of any of aspects 28 through 33, wherein the third control signaling further indicates a duration associated with operating in the inactive state, and the duration comprises a quantity of DRX cycles associated with operating in the inactive state, a quantity of subframes associated with operating in the inactive state, a quantity of slots associated with operating in the inactive state, or any combination thereof.

Aspect 35: A method for wireless communications at a network entity, comprising: outputting first control signaling indicating a plurality of DRX cycles, wherein each DRX cycle of the plurality of DRX cycles comprises a respective first duration associated with an active state at a UE, a respective second duration associated with an inactive state at the UE, or both; outputting, during the active state of a first DRX cycle, second control signaling indicating that the UE is permitted to autonomously enter the inactive state for one or more DRX cycles of the plurality of DRX cycles; and obtaining, in accordance with outputting the second control signaling, third control signaling comprising an inactive state indication indicating that the UE is to enter the inactive state.

Aspect 36: The method of aspect 35, further comprising: outputting, in accordance with obtaining the inactive state indication, fourth control signaling confirming that the UE is permitted to enter the inactive state.

Aspect 37: The method of aspect 36, further comprising: outputting fifth control signaling indicating for the UE to refrain from entering the inactive state until output of the fourth control signaling, wherein outputting the fourth control signaling is in accordance with outputting the fifth control signaling.

Aspect 38: The method of any of aspects 36 through 37, wherein the fourth control signaling comprises an indication of a power state of the UE while in the inactive state, a duration associated with operating in the inactive state, or both.

Aspect 39: The method of aspect 38, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

Aspect 40: The method of any of aspects 36 through 39, wherein the fourth control signaling indicates a second DRX cycle of the plurality of DRX cycles in which the UE is to enter the active state from the inactive state.

Aspect 41: The method of aspect 35, further comprising: outputting fourth control signaling comprising assistance information associated with an artificial intelligence model at the UE, wherein obtaining the third control signaling is in accordance with outputting the assistance information.

Aspect 42: The method of aspect 41, wherein the assistance information comprises a periodicity metric associated with each communication flow between the UE and the network entity, a jitter metric associated with each communication flow between the UE and the network entity, a priority associated with each communication flow between the UE and the network entity, a PDSB associated with each communication flow between the UE and the network entity, a size of a downlink buffer at the network entity, or any combination thereof.

Aspect 43: The method of aspect 35, further comprising: outputting, in accordance with obtaining the third control signaling, fourth control signaling comprising feedback information associated with an artificial intelligence model at the UE.

Aspect 44: The method of aspect 43, wherein the feedback information comprises a quantity of DCI messages missed by the UE while operating in the inactive state, a bitmap indicating one or more DCI messages of a plurality of DCI messages that were missed by the UE while operating in the inactive state, or both.

Aspect 45: The method of any of aspects 43 through 44, wherein the feedback information indicates one or more data radio bearers that were included in one or more transport blocks that were missed by the UE while operating in the inactive state.

Aspect 46: The method of any of aspects 43 through 45, wherein the feedback information comprises a quantity of packets missed by the UE while operating in the inactive state, a priority of each packet missed by the UE while operating in the inactive state, a source IP address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

Aspect 47: The method of any of aspects 35 through 46, wherein the first control signaling comprises one or more key performance indicators associated with an accuracy of an artificial intelligence model at the UE.

Aspect 48: The method of aspect 47, wherein the one or more key performance indicators comprise a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

Aspect 49: The method of any of aspects 35 through 48, further comprising: outputting an indication of a duration from obtaining the third control signaling, wherein the UE is permitted to enter the inactive state after the duration; and communicating one or more message with the UE during the duration.

Aspect 50: The method of any of aspects 35 through 49, wherein the second control signaling further indicates a plurality of durations associated with operating in the inactive state.

Aspect 51: The method of aspect 50, wherein each duration of the plurality of durations comprises a respective quantity of DRX cycles associated with operating in the inactive state, a respective quantity of subframes associated with operating in the inactive state, a respective quantity of slots associated with operating in the inactive state, or any combination thereof.

Aspect 52: The method of any of aspects 35 through 51, wherein the second control signaling further indicates a timer associated with obtaining the third control signaling, the method further comprising: obtaining the third control signaling in accordance with expiration of the timer, wherein the timer begins in accordance with output of the second control signaling.

Aspect 53: The method of any of aspects 35 through 52, wherein the second control signaling comprises a downlink data indicator, a first value of the downlink data indicator indicates that the network entity is to transmit one or more downlink signals, and a second value of the downlink data indicator indicates that the UE is permitted to autonomously enter the inactive state for the one or more DRX cycles.

Aspect 54: The method of any of aspects 35 through 53, wherein the third control signaling comprises an indication of a power state of the UE while operating in the inactive state, a duration associated with operating in the inactive state, or both.

Aspect 55: The method of aspect 54, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

Aspect 56: The method of any of aspects 54 through 55, wherein the power state of the UE comprises an idle DRX power mode, a connected DRX power mode, a short DRX power mode, or a long DRX power mode.

Aspect 57: A method for wireless communications at a UE, comprising: receiving first control signaling indicating a plurality of DRX cycles, wherein each DRX cycle of the plurality of DRX cycles comprises a respective first duration associated with an active state at the UE, a respective second duration associated with an inactive state at the UE, or both; transmitting second control signaling indicating status information of a set of applications operated by the UE; receiving third control signaling indicating for the UE to enter the inactive state in accordance with the status information of the set of applications operated by the UE; and entering the inactive state in accordance with receiving the third control signaling.

Aspect 58: The method of aspect 57, wherein the status information comprises an indication that a first subset of the set of applications are associated with a first operational status and a second subset of the set of applications are associated with a second operational status, the first operational status associated with increased power consumption at the UE relative to the second operational status, and indicating for the UE to enter the inactive state is based at least in part on the indication of the first subset of the set of applications and the second subset of the set of applications.

Aspect 59: The method of any of aspects 57 through 58, wherein the status information comprises an indication of a respective buffer status of each of the set of applications, and indicating for the UE to enter the inactive state is based at least in part on the indication of the respective buffer status of each of the set of applications.

Aspect 60: The method of any of aspects 57 through 59, wherein the status information comprises an indication of a respective traffic time arrival associated with each of the set of applications, and indicating for the UE to enter the inactive state is based at least in part on the indication of the respective traffic time arrival of each of the set of applications.

Aspect 61: The method of any of aspects 57 through 60, wherein the status information comprises an indication of a respective expected event associated with each of the set of applications, and indicating for the UE to enter the inactive state is based at least in part on the indication of the respective expected event of each of the set of applications.

Aspect 62: The method of any of aspects 57 through 61, wherein the status information comprises an indication of a respective traffic priority associated with each of the set of applications, and indicating for the UE to enter the inactive state is based at least in part on the indication of the respective traffic priority of each of the set of applications.

Aspect 63: The method of any of aspects 57 through 62, wherein the third control signaling further indicates a duration associated with operating in the inactive state, and the duration comprises a quantity of DRX cycles associated with operating in the inactive state, a quantity of subframes associated with operating in the inactive state, a quantity of slots associated with operating in the inactive state, or any combination thereof.

Aspect 64: A UE for wireless communications, comprising one or more memories storing processor-executable code, and one or more processors coupled with the one or more memories and individually or collectively operable to execute the code to cause the UE to perform a method of any of aspects 1 through 26.

Aspect 65: A UE for wireless communications, comprising at least one means for performing a method of any of aspects 1 through 26.

Aspect 66: A non-transitory computer-readable medium storing code for wireless communications, the code comprising instructions executable by one or more processors to perform a method of any of aspects 1 through 26.

Aspect 67: A network entity for wireless communications, comprising one or more memories storing processor-executable code, and one or more processors coupled with the one or more memories and individually or collectively operable to execute the code to cause the network entity to perform a method of any of aspects 28 through 34.

Aspect 68: A network entity for wireless communications, comprising at least one means for performing a method of any of aspects 28 through 34.

Aspect 69: A non-transitory computer-readable medium storing code for wireless communications, the code comprising instructions executable by one or more processors to perform a method of any of aspects 28 through 34.

Aspect 70: A network entity for wireless communications, comprising one or more memories storing processor-executable code, and one or more processors coupled with the one or more memories and individually or collectively operable to execute the code to cause the network entity to perform a method of any of aspects 35 through 56.

Aspect 71: A network entity for wireless communications, comprising at least one means for performing a method of any of aspects 35 through 56.

Aspect 72: A non-transitory computer-readable medium storing code for wireless communications, the code comprising instructions executable by one or more processors to perform a method of any of aspects 35 through 56.

Aspect 73: A UE for wireless communications, comprising one or more memories storing processor-executable code, and one or more processors coupled with the one or more memories and individually or collectively operable to execute the code to cause the UE to perform a method of any of aspects 57 through 63.

Aspect 74: A UE for wireless communications, comprising at least one means for performing a method of any of aspects 57 through 63.

Aspect 75: A non-transitory computer-readable medium storing code for wireless communications, the code comprising instructions executable by one or more processors to perform a method of any of aspects 57 through 63.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a plurality of discontinuous reception (DRX) cycles, wherein each DRX cycle of the plurality of DRX cycles comprises a respective first duration associated with an active state at the UE, a respective second duration associated with an inactive state at the UE, or both;
receive, during the active state of a first DRX cycle, second control signaling indicating that the UE is permitted to autonomously enter the inactive state for one or more DRX cycles of the plurality of DRX cycles;
transmit, in accordance with receiving the second control signaling, third control signaling comprising an inactive state indication indicating that the UE is to enter the inactive state, wherein the inactive state indication of the UE is in accordance with an output of an artificial intelligence model at the UE; and
enter the inactive state.

2. The UE of claim 1, wherein the one or more processors are individually or collectively further operable to execute the code to cause the UE to:
receive, in accordance with transmitting the inactive state indication, fourth control signaling confirming that the UE is permitted to enter the inactive state, wherein entering the inactive state is in accordance with receiving the fourth control signaling.

3. The UE of claim 2, wherein the one or more processors are individually or collectively further operable to execute the code to cause the UE to:
receive fifth control signaling indicating for the UE to refrain from entering the inactive state until reception of the fourth control signaling, wherein receiving the fourth control signaling is in accordance with receiving the fifth control signaling.

4. The UE of claim 2, wherein the fourth control signaling comprises an indication of a power state of the UE while in the inactive state, a duration associated with operating in the inactive state, or both.

5. The UE of claim 4, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

6. The UE of claim 2, wherein the fourth control signaling indicates a second DRX cycle of the plurality of DRX cycles in which the UE is to enter the active state from the inactive state.

7. The UE of claim 1, wherein the one or more processors are individually or collectively further operable to execute the code to cause the UE to:
receive fourth control signaling comprising assistance information associated with the artificial intelligence model at the UE, wherein the UE uses the assistance information as inputs into the artificial intelligence model at the UE, and wherein transmitting the third control signaling is in accordance with the assistance information.

8. The UE of claim 7, wherein the assistance information comprises a periodicity metric associated with each communication flow between the UE and a network entity, a jitter metric associated with each communication flow between the UE and the network entity, a priority associated with each communication flow between the UE and the network entity, a packet data unit set delay budget (PDSB) associated with each communication flow between the UE and the network entity, a size of a downlink buffer at the network entity, or any combination thereof.

9. The UE of claim 1, wherein the one or more processors are individually or collectively further operable to execute the code to cause the UE to:
receive, in accordance with entering the active state from the inactive state, fourth control signaling comprising feedback information associated with the artificial intelligence model at the UE; and
update the artificial intelligence model at the UE in accordance with the feedback information.

10. The UE of claim 9, wherein the feedback information comprises a quantity of downlink control information (DCI) messages missed by the UE while operating in the inactive state, a bitmap indicating one or more DCI messages of a plurality of DCI messages that were missed by the UE while operating in the inactive state, or both.

11. The UE of claim 9, wherein the feedback information indicates one or more data radio bearers that were included in one or more transport blocks that were missed by the UE while operating in the inactive state.

12. The UE of claim 9, wherein the feedback information comprises a quantity of packets missed by the UE while operating in the inactive state, a priority of each packet missed by the UE while operating in the inactive state, a source internet protocol (IP) address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

13. The UE of claim 1, wherein the one or more processors are individually or collectively further operable to execute the code to cause the UE to:
determine, using the artificial intelligence model, one or more parameters associated with entering the inactive state in accordance with one or more inputs, wherein transmitting the third control signaling is in accordance with the one or more parameters determined using the artificial intelligence model, wherein the output of the artificial intelligence model comprises the one or more parameters.

14. The UE of claim 13, wherein the one or more parameters comprise a time associated with entering the inactive state, a power state of the UE while operating in the inactive state, a duration associated with operating in the inactive state, or any combination thereof.

15. The UE of claim 13, wherein the one or more inputs comprise a packet data unit delay budget (PDB) associated with each communication flow between the UE and a network entity, a packet data unit set delay budget (PDSB) associated with each communication flow between the UE and the network entity, a priority associated with each communication flow between the UE and the network entity, a latency associated with each communication flow between the UE and the network entity, a packet data unit set completion percentage associated with each communication flow between the UE and the network entity, or any combination thereof.

16. The UE of claim 13, wherein the one or more inputs comprise an uplink traffic buffer at the UE, a predicted uplink traffic buffer at the UE, one or more operational parameters associated with one or more applications operated by the UE, one or more power parameters at the UE, one or more sleep cycles at the UE, or any combination thereof.

17. The UE of claim 1, wherein the first control signaling comprises one or more key performance indicators associated with an accuracy of the artificial intelligence model at the UE, and the one or more processors are individually or collectively further operable to execute the code to cause the UE to:
update the artificial intelligence model to satisfy the one or more key performance indicators.

18. The UE of claim 17, wherein the one or more key performance indicators comprise a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

19. The UE of claim 1, wherein, to enter the inactive state, the one or more processors are individually or collectively operable to execute the code to cause the UE to:
enter the inactive state after a duration from transmission of the third control signaling, wherein the duration is indicated via the first control signaling, the second control signaling, or a fourth control signaling.

20. The UE of claim 1, wherein the second control signaling further indicates a plurality of durations associated with operating in the inactive state, and the one or more processors are individually or collectively further operable to execute the code to cause the UE to:
operate within the inactive state for one of the plurality of durations.

21. The UE of claim 20, wherein each duration of the plurality of durations comprises a respective quantity of DRX cycles associated with operating in the inactive state, a respective quantity of subframes associated with operating in the inactive state, a respective quantity of slots associated with operating in the inactive state, or any combination thereof.

22. The UE of claim 1, wherein the second control signaling further indicates a timer associated with transmission of the third control signaling, and the one or more processors are individually or collectively further operable to execute the code to cause the UE to:
transmit the third control signaling in accordance with expiration of the timer, wherein the timer begins in accordance with reception of the second control signaling at the UE.

23. The UE of claim 1, wherein:
the second control signaling comprises a downlink data indicator,
a first value of the downlink data indicator indicates that the UE is to receive one or more downlink signals, and
a second value of the downlink data indicator indicates that the UE is permitted to autonomously enter the inactive state for the one or more DRX cycles.

24. The UE of claim 1, wherein the third control signaling comprises an indication of a power state of the UE while operating in the inactive state, a duration associated with operating in the inactive state, or both.

25. The UE of claim 24, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

26. The UE of claim 24, wherein the power state of the UE comprises an idle DRX power mode, a connected DRX power mode, a short DRX power mode, or a long DRX power mode.

27. The UE of claim 1, wherein the UE enters the inactive state in accordance with transmitting the third control signaling.

28. A network entity, comprising:
one or more memories storing processor-executable code; and
one or more processors coupled with the one or more memories and individually or collectively operable to execute the code to cause the network entity to:
output first control signaling indicating a plurality of discontinuous reception (DRX) cycles, wherein each DRX cycle of the plurality of DRX cycles comprises a respective first duration associated with an active state at a user equipment (UE), a respective second duration associated with an inactive state at the UE, or both;
obtain second control signaling indicating status information of a set of applications operated by the UE; and
output third control signaling indicating for the UE to enter the inactive state in accordance with an artificial intelligence model operated at the network entity, wherein the status information is an input to the artificial intelligence model.

29. The network entity of claim 28, wherein the status information comprises an indication that a first subset of the set of applications are associated with a first operational status and a second subset of the set of applications are associated with a second operational status, the first operational status associated with increased power consumption at the UE relative to the second operational status, and indicating for the UE to enter the inactive state is based at least in part on the indication of the first subset of the set of applications and the second subset of the set of applications.

30. The network entity of claim 28, wherein the status information comprises an indication of a respective buffer status of each of the set of applications, and indicating for the UE to enter the inactive state is based at least in part on the indication of the respective buffer status of each of the set of applications.

31. The network entity of claim 28, wherein the status information comprise an indication of a respective traffic time arrival associated with each of the set of applications, and indicating for the UE to enter the inactive state is based at least in part on the indication of the respective traffic time arrival of each of the set of applications.

32. The network entity of claim 28, wherein the status information comprises an indication of a respective expected event associated with each of the set of applications, and indicating for the UE to enter the inactive state is based at least in part on the indication of the respective expected event of each of the set of applications.

33. The network entity of claim 28, wherein the status information comprises an indication of a respective traffic priority associated with each of the set of applications, and indicating for the UE to enter the inactive state is based at least in part on the indication of the respective traffic priority of each of the set of applications.

34. The network entity of claim 28, wherein:
the third control signaling further indicates a duration associated with operating in the inactive state, and
the duration comprises a quantity of DRX cycles associated with operating in the inactive state, a quantity of subframes associated with operating in the inactive state, a quantity of slots associated with operating in the inactive state, or any combination thereof.

35. A network entity, comprising:
one or more memories storing processor-executable code; and
one or more processors coupled with the one or more memories and individually or collectively operable to execute the code to cause the network entity to:
output first control signaling indicating a plurality of discontinuous reception (DRX) cycles, wherein each DRX cycle of the plurality of DRX cycles comprises a respective first duration associated with an active state at a user equipment (UE), a respective second duration associated with an inactive state at the UE, or both;
output, during the active state of a first DRX cycle, second control signaling indicating that the UE is permitted to autonomously enter the inactive state for one or more DRX cycles of the plurality of DRX cycles; and
obtain, in accordance with outputting the second control signaling, third control signaling comprising an inactive state indication indicating that the UE is to enter the inactive state.

36. The network entity of claim 35, wherein the one or more processors are individually or collectively further operable to execute the code to cause the network entity to:
output, in accordance with obtaining the inactive state indication, fourth control signaling confirming that the UE is permitted to enter the inactive state.

37. The network entity of claim 36, wherein the one or more processors are individually or collectively further operable to execute the code to cause the network entity to:
output fifth control signaling indicating for the UE to refrain from entering the inactive state until output of the fourth control signaling, wherein outputting the fourth control signaling is in accordance with outputting the fifth control signaling.

38. The network entity of claim 36, wherein the fourth control signaling comprises an indication of a power state of the UE while in the inactive state, a duration associated with operating in the inactive state, or both.

39. The network entity of claim 38, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

40. The network entity of claim 36, wherein the fourth control signaling indicates a second DRX cycle of the plurality of DRX cycles in which the UE is to enter the active state from the inactive state.

41. The network entity of claim 35, wherein the one or more processors are individually or collectively further operable to execute the code to cause the network entity to:
output fourth control signaling comprising assistance information associated with an artificial intelligence model at the UE, wherein obtaining the third control signaling is in accordance with outputting the assistance information.

42. The network entity of claim 41, wherein the assistance information comprises a periodicity metric associated with each communication flow between the UE and the network entity, a jitter metric associated with each communication flow between the UE and the network entity, a priority associated with each communication flow between the UE and the network entity, a packet data unit set delay budget (PDSB) associated with each communication flow between the UE and the network entity, a size of a downlink buffer at the network entity, or any combination thereof.

43. The network entity of claim 35, wherein the one or more processors are individually or collectively further operable to execute the code to cause the network entity to:
output, in accordance with obtaining the third control signaling, fourth control signaling comprising feedback information associated with an artificial intelligence model at the UE.

44. The network entity of claim 43, wherein the feedback information comprises a quantity of downlink control information (DCI) messages missed by the UE while operating in the inactive state, a bitmap indicating one or more DCI messages of a plurality of DCI messages that were missed by the UE while operating in the inactive state, or both.

45. The network entity of claim 43, wherein the feedback information indicates one or more data radio bearers that were included in one or more transport blocks that were missed by the UE while operating in the inactive state.

46. The network entity of claim 43, wherein the feedback information comprises a quantity of packets missed by the UE while operating in the inactive state, a priority of each packet missed by the UE while operating in the inactive state, a source internet protocol (IP) address of each packet missed by the UE while operating in the inactive state, a source port of each packet missed by the UE while operating in the inactive state, a destination IP address of each packet missed by the UE while operating in the inactive state, a destination port of each packet missed by the UE while operating in the inactive state, a transportation protocol of each packet missed by the UE while operating in the inactive state, or a combination thereof.

47. The network entity of claim 35, wherein the first control signaling comprises one or more key performance indicators associated with an accuracy of an artificial intelligence model at the UE.

48. The network entity of claim 47, wherein the one or more key performance indicators comprise a threshold duration associated with the UE operating in the inactive state, a threshold quantity of packets missed by the UE while operating in the inactive state, a threshold percentage of packets missed by the UE while operating in the inactive state, a threshold quantity of data radio bearers per transport block missed by the UE while operating in the inactive state, or any combination thereof.

49. The network entity of claim 35, wherein the one or more processors are individually or collectively further operable to execute the code to cause the network entity to:
output an indication of a duration from obtaining the third control signaling, wherein the UE is permitted to enter the inactive state after the duration; and
communicate one or more message with the UE during the duration.

50. The network entity of claim 35, wherein the second control signaling further indicates a plurality of durations associated with operating in the inactive state.

51. The network entity of claim 50, wherein each duration of the plurality of durations comprises a respective quantity of DRX cycles associated with operating in the inactive state, a respective quantity of subframes associated with operating in the inactive state, a respective quantity of slots associated with operating in the inactive state, or any combination thereof.

52. The network entity of claim 35, wherein the second control signaling further indicates a timer associated with obtaining the third control signaling, and the one or more processors are individually or collectively further operable to execute the code to cause the network entity to:
obtain the third control signaling in accordance with expiration of the timer, wherein the timer begins in accordance with output of the second control signaling.

53. The network entity of claim 35, wherein:
the second control signaling comprises a downlink data indicator,
a first value of the downlink data indicator indicates that the network entity is to transmit one or more downlink signals, and
a second value of the downlink data indicator indicates that the UE is permitted to autonomously enter the inactive state for the one or more DRX cycles.

54. The network entity of claim 35, wherein the third control signaling comprises an indication of a power state of the UE while operating in the inactive state, a duration associated with operating in the inactive state, or both.

55. The network entity of claim 54, wherein the duration associated with operating in the inactive state comprises a quantity of DRX cycles associated with operating in the inactive state, a quantity of subframes associated with operating in the inactive state, a quantity of slots associated with operating in the inactive state, or any combination thereof.

56. The network entity of claim 54, wherein the power state of the UE comprises an idle DRX power mode, a connected DRX power mode, a short DRX power mode, or a long DRX power mode.

57. A user equipment (UE), comprising:
one or more memories storing processor-executable code; and
one or more processors coupled with the one or more memories and individually or collectively operable to execute the code to cause the UE to:
receive first control signaling indicating a plurality of discontinuous reception (DRX) cycles, wherein each DRX cycle of the plurality of DRX cycles comprises a respective first duration associated with an active state at the UE, a respective second duration associated with an inactive state at the UE, or both;
transmit second control signaling indicating status information of a set of applications operated by the UE;
receive third control signaling indicating for the UE to enter the inactive state in accordance with the status information of the set of applications operated by the UE; and
enter the inactive state in accordance with receiving the third control signaling.

58. The UE of claim 57, wherein the status information comprises an indication that a first subset of the set of applications are associated with a first operational status and a second subset of the set of applications are associated with a second operational status, the first operational status associated with increased power consumption at the UE relative to the second operational status, and indicating for the UE to enter the inactive state is based at least in part on the indication of the first subset of the set of applications and the second subset of the set of applications.

59. The UE of claim 57, wherein the status information comprises an indication of a respective buffer status of each of the set of applications, and indicating for the UE to enter the inactive state is based at least in part on the indication of the respective buffer status of each of the set of applications.

60. The UE of claim 57, wherein the status information comprises an indication of a respective traffic time arrival associated with each of the set of applications, and indicating for the UE to enter the inactive state is based at least in part on the indication of the respective traffic time arrival of each of the set of applications.

61. The UE of claim 57, wherein the status information comprises an indication of a respective expected event associated with each of the set of applications, and indicating for the UE to enter the inactive state is based at least in part on the indication of the respective expected event of each of the set of applications.

62. The UE of claim 57, wherein the status information comprises an indication of a respective traffic priority associated with each of the set of applications, and indicating for the UE to enter the inactive state is based at least in part on the indication of the respective traffic priority of each of the set of applications.

63. The UE of claim 57, wherein:
the third control signaling further indicates a duration associated with operating in the inactive state, and
the duration comprises a quantity of DRX cycles associated with operating in the inactive state, a quantity of subframes associated with operating in the inactive state, a quantity of slots associated with operating in the inactive state, or any combination thereof.
